(19) United States
(12) Patent Application Publication
(10) Pub. No.: US 2008/0048437 A1
(43) Pub. Date: Feb. 28, 2008

(54) Method and apparatus for end-to-end coupling of component bores

(76) Inventors: Tom M. Simmons, Hemlock, MI (US); John M. Simmons, Hemlock, MI (US); David M. Simmons, Saginaw, MI (US)

Correspondence Address: TRASK BRITT, P.O. BOX 2550, SALT LAKE CITY, UT, 84110, US

(21) Appl. No.: 11/475,790

(22) Filed: Jun. 27, 2006

(51) Int. Cl. F16L 39/00

(52) U.S. Cl. 285/124.5

(57) ABSTRACT

A coupling assembly including a protruding annular nose portion having a longitudinal axis and a bore extending coaxially therethrough extending from a first component. The nose portion includes a frustoconical outer surface tapering radially inwardly toward the distal end thereof where the frustoconical outer surface meets the wall of the first component bore. A second component comprises a body carrying an annular skirt extending coaxially about a longitudinal axis and defining an entry bore, the annular skirt being separated from a surrounding, annular coupling bore wall of the second component by an annular recess therebetween. At the bottom of the annular recess may, optionally, be disposed a skirt compression adjustment ferrule, which may be integral with the body or formed as a separate component. A method of coupling component bores end-to-end is also disclosed.

### BACKGROUND OF THE INVENTION

1. Field of the Invention

The present invention relates generally to coupling fluid flow components having bores therethrough.

2. State of the Art

Numerous industries and many applications utilize metallic tubes, fittings, and various other “plumbing” components for handling and controlling critical fluid flow. Such components may be made of copper, stainless steel, and steel. Where the fluids being handled are under significant pressure or where containment integrity is critical, seals such as O-rings and flexible flat gaskets are typically utilized.

In particular applications such as semiconductor processing, the fluids involved react with and/or may be contaminated by the use of metallic components and conventional gaskets and elastomeric O-rings. Thus, in such industries, plumbing components are made of highly inert materials such as fluoropolymers, i.e., PFA and PTFE, for wetted components. In such applications, elastomeric O-rings are typically formed of two materials with a first traditional elastomeric material, such as silicon, encapsulated in a fluoropolymer coating. These O-rings are expensive and are subject to degradation and are typically considered to be suited for only a single use.

Various fluoropolymer-based fittings and couplings have evolved for making connections between fluoropolymer components that do not utilize O-rings. One typical type of fitting is known in the industry as a FLARETEK.R™ fitting. FLARETEK is a registered trademark of Fluoroware, Inc. of Chaska Minn. In such a fitting, one component having an elongated, tapered nose section with a threaded neck is inserted within a tubular end portion of another component which is flared to fit over the tapered nose section. The flared area of the tubular end portion typically has an inside cylindrical surface with a diameter sized to receive closely the outside diameter of the cylindrical surface of the nose section. An internally threaded nut disposed over the flared tubular end portion of another component is used to tighten the flared section about the nose to create a seal between the elongated, tapered nose section and the flared end portion. The flared end portion of the tubing is typically formed by heating and shaping the heated, malleable end portion into the desired flared configuration using Teflon® or stainless steel forms.

Various other types of fluoropolymer fittings are known in the art. Some utilize separate gripper portions or internal ferrules. See for example U.S. Pat. Nos. 3,977,708 and 4,848,802. For connections between fluoropolymer valves and components such as fluoropolymer manifolds, sealing integrity between the components is typically accomplished by gaskets or fluoropolymer covered O-rings. In certain instances annular tongue-in-groove connections without O-rings or gaskets have been successfully utilized. These connections have the disadvantage that they must be precisely machined, i.e., tolerances of 0.0005 inches, and it can be difficult to properly align the mating pieces. Moreover, such connections are vulnerable to nicks and scratches, which can compromise the integrity of the connection. Such a tongue-in-groove fitting is illustrated by U.S. Pat. No. 5,645,301. All of these fittings include a flange having a circumferential edge that defines its outside diameter. The circumferential edge is threaded to accommodate threaded connection with a coupling nut.

As may also be appreciated, it would be advantageous to provide a coupling accommodating a bore of maximum size relative to a minimum outside diameter wherein use of an elongated tube element of one component extending completely over an end of a mating component is undesirable or impossible to employ.

### BRIEF SUMMARY OF THE INVENTION

One embodiment of the present invention comprises a coupling assembly including a protruding annular nose portion having a longitudinal axis and a bore extending coaxially therethrough extending from a first component. The coupling assembly components may be formed of a fluoropolymer such as, by way of example only, PFA or PTFE. The nose portion includes a frustoconical outer surface tapering radially inwardly toward the distal end thereof, terminating at a relatively sharp annular edge, which may comprise a very small radius, where the frustoconical outer surface meets the wall of the first component bore. The base of the frustoconical nose portion may, optionally, comprise a cylindrical surface, or a frustoconical surface exhibiting a lesser angle of taper. The nose portion may comprise an integral portion of the first component, or be a discrete structure removable and replaceable thereon. A second component comprises a body carrying an annular skirt extending coaxially about a longitudinal axis and defining an entry, the annular skirt being separated from a surrounding, annular coupling bore wall of the second component by an annular recess therebetween. At the bottom of the annular recess may be disposed a skirt compression adjustment ferrule, which may be integral with the body or formed as a separate component. The distal end of the annular skirt may, optionally, comprise a chamfer at the junction of the skirt longitudinal end face and the wall of the entry bore about which the annular skirt extends. The chamfer angle may approximate the angle of the frustoconical surface of the first component.

The length of the annular outer surface of the nose portion of the first component along the surface thereof may approximate a longitudinal length of the annular skirt, measured from a base thereof laterally adjacent the bottom of the annular recess. Further, the longitudinal length of the nose portion may be selected relative to a face surface of the first component which abuts a face surface of the second component when the first and second components are coupled to control the insertion depth of the nose portion into the annular skirt. Thus, the insertion depth may be optimized to provide a substantially uninterrupted, smooth-walled bore of substantially constant diameter extending through the coupling assembly.

In use, the protruding annular nose portion of the first component is inserted coaxially within the annular skirt and the first and second components forced toward one another along the aligned longitudinal axes of the two components. The protruding annular nose portion of the first component inserted into the annular skirt of the second component spreads the annular skirt radially outwardly as the inner surface of the annular skirt defining the entry bore sealingly conforms to the frustoconical outer surface of the protruding annular nose portion due to the resiliency of the annular skirt. The annular skirt is permitted to spread outwardly into the annular recess as the nose portion extends thereinto, and its relatively short length prevents contact with the outer wall of the annular recess at least until the annular outer surface of the nose portion is substantially received within the annular skirt, and prevents binding with the outer wall of the annular recess and any portion of the first component proximal of the outer frustoconical surface of the nose portion which would comprise the seal of the coupling assembly. The resistance of the annular skirt to deformation and, thus, the amount of force required to mate the first and second components and the tightness of the resulting seal between the annular skirt and the frustoconical outer surface may be set or adjusted by the presence of a skirt compression adjustment ferrule, in combination with the material characteristics of the skirt (particularly if separately formed), the radial thickness thereof and the axial length thereof receiving the protruding nose portion. As noted above, the skirt may be formed of a fluoropolymer, which “cold flows” under applied force, rather than being resilient, even in the absence of application of heat.

In one embodiment, the body carrying the annular skirt may be an integral part of the second component which may, for example, comprise a manifold with a plurality of branch bores in communication with a main bore. An annular skirt compression ferrule may or may not be employed and, if employed, may be formed as an integral part of the second component or may be separately formed.

In another embodiment, the body may comprise an adapter disposed in an adapter bore in the second component, wherein the surrounding, annular coupling bore wall also comprises the wall of the adapter bore and the bottom of the adapter comprises an annular extension or protrusion at a periphery thereof sealingly engaged, as by an interference fit, with an annular groove in the bottom of the adapter bore adjacent the periphery thereof. As before, an annular skirt compression ferrule may or may not be employed and, if employed, may be formed as an integral part of the second component (in this case, of the adapter) or may be separately formed.

In yet another embodiment, the body may comprise an adapter secured to a face of the second component and the annular skirt formed in the adapter in spaced relationship to the coupling bore wall, a fluid-tight seal being provided between the second component and the adapter by an annular extension or protrusion in one of the second component and the adapter and a mating annular groove in the other of the second component and the adapter. As before, an annular skirt compression ferrule may or may not be employed and, if employed, may be formed as an integral part of the second component (in this case, the adapter) or may be separately formed.

In still another embodiment, the body may comprise an adapter threaded on an exterior surface thereof, having the annular skirt formed therein in spaced relationship to the coupling bore wall, the adapter threads being engaged with internal threads of an adapter bore of the second component. Again, a seal between the adapter and the second component may comprise a mating peripheral extension or protrusion and groove structure. Optionally, the adapter may include a flange at the top thereof which is received in a counterbore at the mouth of the adapter bore above the threads of the adapter bore, to provide a positive stop to the depth to which the adapter extends into the insert bore. The counterbore and an upper, smooth-walled portion of the adapter bore above the threads may be formed in the primary structure of the second component, or in a block secured to the main body. As before, an annular skirt compression ferrule may or may not be employed and, if employed, may be formed as an integral part of the second component (in this case, the adapter or may be separately formed. Further, the adapter itself may comprise an insert of which the annular skirt is a part, the insert being received in an insert bore in the adapter, sealingly engaged therewith and providing a surface on which an annular compression skirt may be disposed.

The embodiments of the present invention employing adapters enable easy removal and replacement of elements of the coupling assembly due to damage, leakage, contamination or contemplated use of the first and second components with different fluids. Similarly, the use of annular skirt compression adjustment ferrules enables accommodation of both liquid and gas transmission through the same components at various pressures by providing the capability of forming seals capable of withstanding the contemplated pressure to be used at a given coupling assembly. Of course, the use of separately formed skirt compression adjustment ferrules enables extremely fine tuning of the robustness of the seal obtained. The use of adapters and replaceable nose portions also enable easy conversion of existing components having bores therethrough to the coupling assembly of the present invention.

The first and second components may each comprise a single bore to be coupled, or one component may comprise a plurality of bores and a like plurality of bores formed in the other component. Further, one component, such as a manifold, may comprise a plurality of bores and a plurality of mating components such as a plurality of valve blocks each having a single bore for coupling, may be coupled thereto. In any case, a first component may be secured to a second component with the respective bores thereof in alignment using screws, bolts, clamps or other conventional fasteners known to those of ordinary skill in the art.

### BRIEF DESCRIPTION OF THE SEVERAL VIEWS OF THE DRAWINGS

The foregoing and other advantages of the present invention will become apparent upon review of the following detailed description and drawings in which:

FIG. 1A is a side sectional view of a second component in the form of a manifold aligned with a plurality of first components prior to assembly, employing a coupling assembly according to a first embodiment of the present invention;

FIG. 1B is a side sectional view of the first and second components of FIG. 1A, after assembly;

FIG. 2A is a side sectional view of a second component in the form of a manifold aligned with a plurality of first components prior to assembly, employing a coupling assembly according to a second embodiment of the present invention;

FIG. 2B is a side sectional view of the first and second components of FIG. 2A, after assembly;

FIG. 3A is a side sectional view of a second component in the form of a manifold aligned with a plurality of first components prior to assembly, employing a coupling assembly according to a third embodiment of the present invention;

FIG. 3B is a side sectional view of the first and second components of FIG. 3A, after assembly;

FIG. 4A is a side sectional view of a second component in the form of a manifold aligned with a plurality of first components prior to assembly, employing a coupling assembly according to a fourth embodiment of the present invention;

FIG. 4B is a side sectional view of the first and second components of FIG. 4A, after assembly;

FIG. 5A is a side sectional view of a second component in the form of a manifold aligned with a plurality of first components prior to assembly, employing a coupling assembly according to a fifth embodiment of the present invention;

FIG. 5B is a side sectional view of the first and second components of FIG. 5A, after assembly;

FIG. 6A is a side sectional view of a second component in the form of a manifold aligned with a plurality of first components prior to assembly, employing a coupling assembly according to a sixth embodiment of the present invention;

FIG. 6B is a side sectional view of the first and second components of FIG. 6A, after assembly;

FIG. 7A is a side sectional view of a second component in the form of a manifold aligned with a plurality of first components prior to assembly, employing a coupling assembly according to a seventh embodiment of the present invention;

FIG. 7B is a side sectional view of the first and second components of FIG. 7A, after assembly;

FIG. 8A is a side sectional view of a second component in the form of a manifold aligned with a plurality of first components prior to assembly, employing a coupling assembly according to an eighth embodiment of the present invention;

FIG. 8B is a side sectional view of the first and second components of FIG. 8A, after assembly;

FIG. 9A is a side sectional view of a second component in the form of a manifold aligned with a plurality of first components prior to assembly, employing a coupling assembly according to a ninth embodiment of the present invention;

FIG. 9B is a side sectional view of the first and second components of FIG. 9A, after assembly;

FIG. 10 depicts a further embodiment of the present invention, which embodiment employs a double-ended nose insert to sealingly join two other components including annular skirts;

FIG. 11 depicts another embodiment of the present invention, wherein a valve block and an adapter block are threaded together; and

FIG. 12 depicts still further embodiments of the present invention, wherein an adapter block and a manifold may be connected using the coupling of the present invention.

### DETAILED DESCRIPTION OF THE INVENTION

The coupling according to the present invention may be used in a variety of applications, such as for coupling pipe or tubing ends to items such as valves or manifolds, for coupling a valve block to a manifold, or a pump to an inlet or outlet header. In the following detailed description, like elements are identified with like reference numerals for clarity.

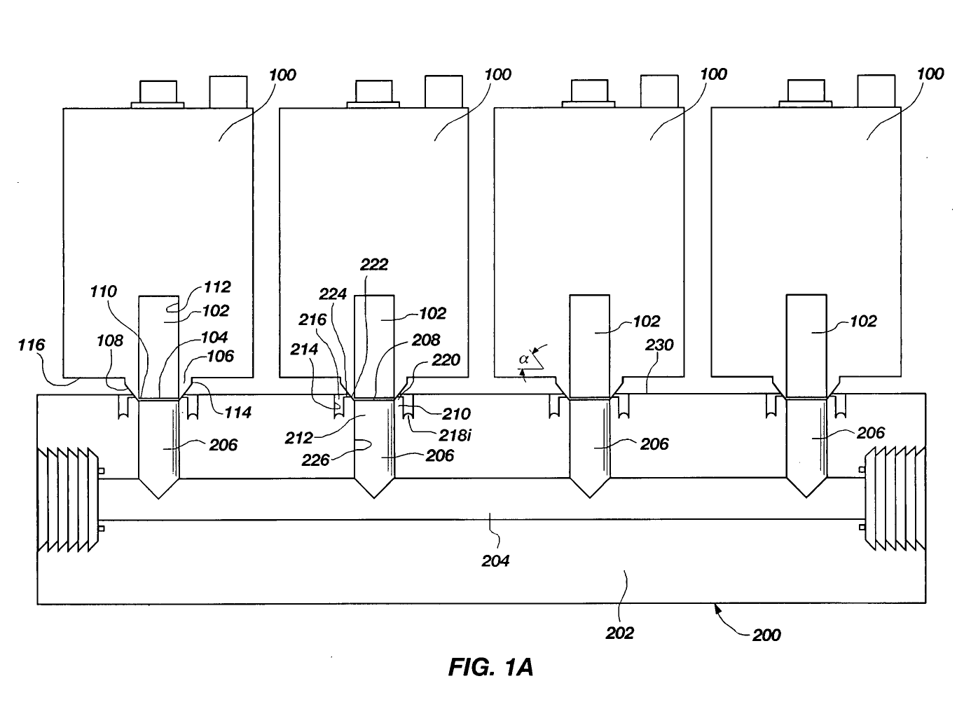

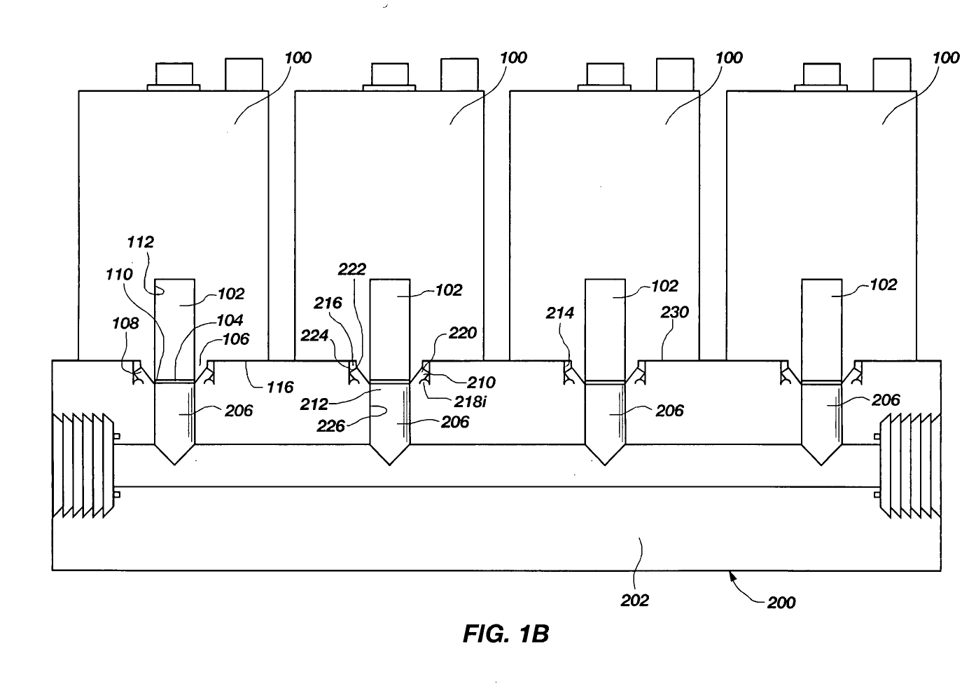

A first embodiment of a coupling assembly according to the present invention is depicted in FIGS. 1A and 1B. A plurality of first components in the form of valve blocks 100 is shown disposed above (as the drawing sheet is oriented) a second component in the form of manifold 200.

Each valve block 100 (valve not shown for clarity) comprises a bore 102 extending thereinto and having a mouth 104 circumscribed by protruding annular nose portion 106. The nose portion 106 includes a frustoconical outer surface 108 tapering radially inwardly toward the distal end 110 thereof, terminating at a relatively sharp annular edge at the junction with bore wall 112, which junction may comprise a very small flat, chamfer or radius. By way of example only, bore 102 may be of a 0.25 inch diameter. Proximally behind frustoconical outer surface 108, cylindrical outer surface 114 extends to face surface 116 of valve block 100.

The manifold 200 includes a block 202 with a primary fluid flow path in the form of longitudinal bore 204 extending therethrough. Four (by way of example only) side, branch bores 206 extend from longitudinal bore 204. The upper end (as the drawing sheet is oriented) of each branch bore 206 terminates at a mouth 208 circumscribed by an annular skirt 210 extending coaxially about a longitudinal axis of branch bore 206 and defining an entry bore 212 of like diameter (e.g., 0.25 inch) to that of a bore 102 of a valve block 100, the annular skirt 210 having a radial wall thickness of, for the sake of example only, 0.060 inch. Annular skirt 210 is radially separated from a surrounding, annular coupling bore wall 214 of manifold 200 by an annular recess 216 therebetween. At the bottom of the annular recess 216 is coaxially disposed an annular skirt compression adjustment ferrule 218i, which in this embodiment is formed as an integral part of manifold 200 and is substantially semicircular shape in transverse cross section. The distal end 220 of the annular skirt 210 may, optionally, comprise a chamfer or radius 222 at the junction of the skirt longitudinal end face 224 and the wall 226 of the entry bore 212 about which the annular skirt 210 extends. The chamfer angle α may approximate the angle of the frustoconical outer surface 108 of the first component.

In use and as shown in FIG. 1B, the protruding annular nose portion 106 of valve block 100 is inserted coaxially within the annular skirt 210 and the valve block 100 and manifold 200 forced toward one another along the aligned longitudinal axes of the two components until face surface 116 of valve block 100 from which protruding annular nose portion 106 extends lies proximate and, optionally, may abut face surface 230 of manifold 200 surrounding one of the annular recesses 216 encompassing annular skirt 210 defining entry bore 212. The protruding annular nose portion 106 of the valve block 100 inserted into the annular skirt of the manifold 200 spreads the annular skirt 210 radially outwardly as the inner surface of the annular skirt defining the bore wall 226 of entry bore 212 sealingly conforms to the frustoconical outer surface 108 of the protruding annular nose portion 106 due to the resiliency of the annular skirt 210. As noted above, the resistance of the annular skirt 210 to deformation and, thus, the amount of force required to mate the nose portion 106 with skirt 210 and the tightness of the resulting seal therebetween may be set or adjusted by the presence of annular skirt compression adjustment ferrule 218i (and the dimensions and cross-sectional shape thereof, the material in this embodiment being the same as that of manifold 200), in combination with the material characteristics of the skirt, the radial thickness thereof and the axial length thereof receiving the protruding nose portion. As may be appreciated by reference to FIG. 1B, the wall of annular skirt 210 is compressed radially between frustoconical outer surface 108 of nose portion 106 and the arcuate exterior surface of annular skirt compression ferrule 218i, such compression resulting in a more robust engagement between bore wall 226 and frustoconical outer surface 108.

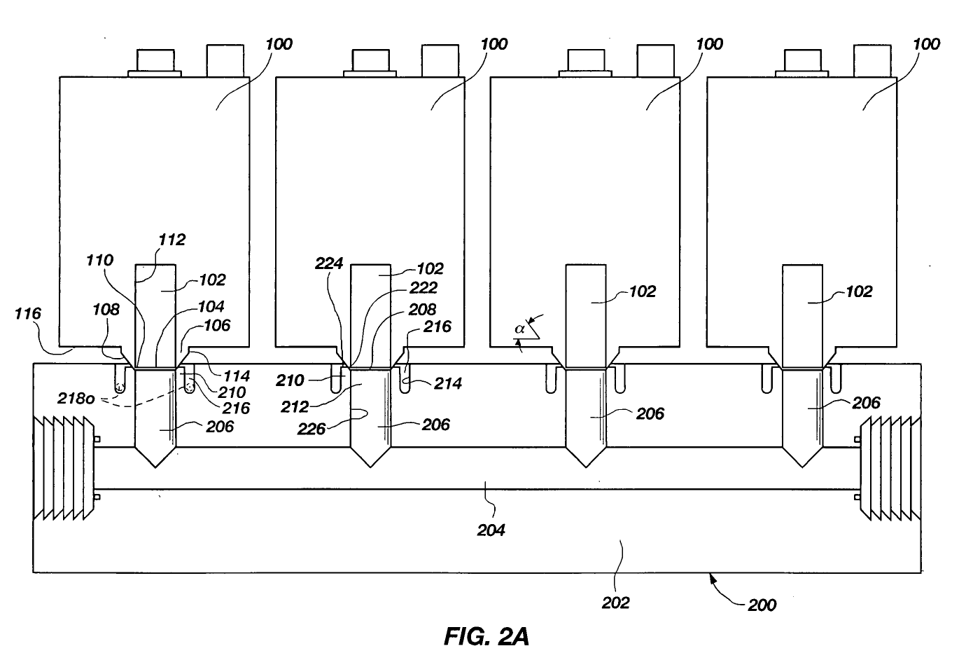

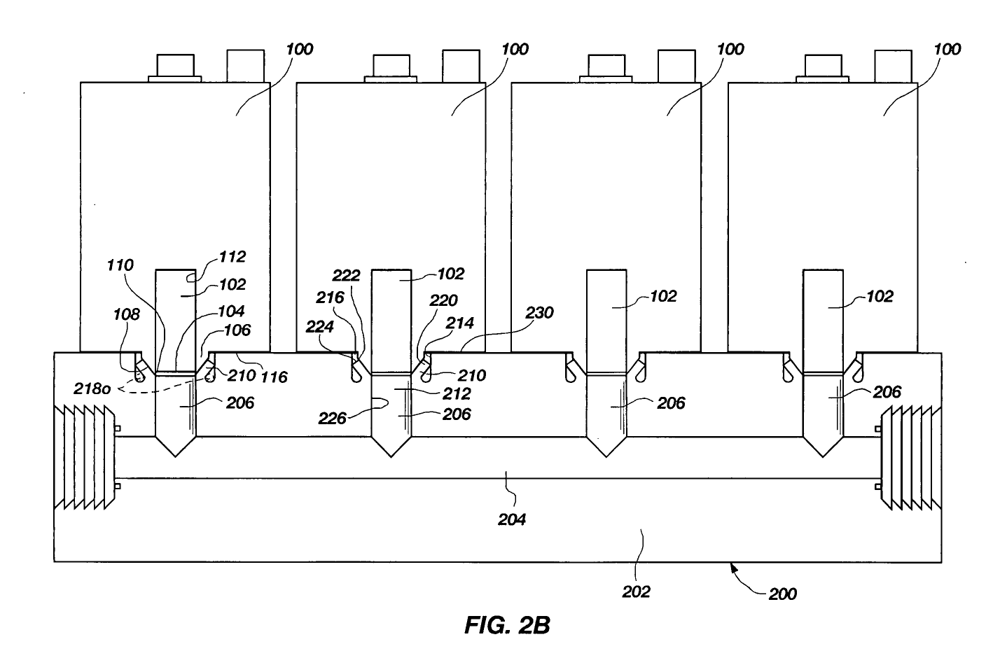

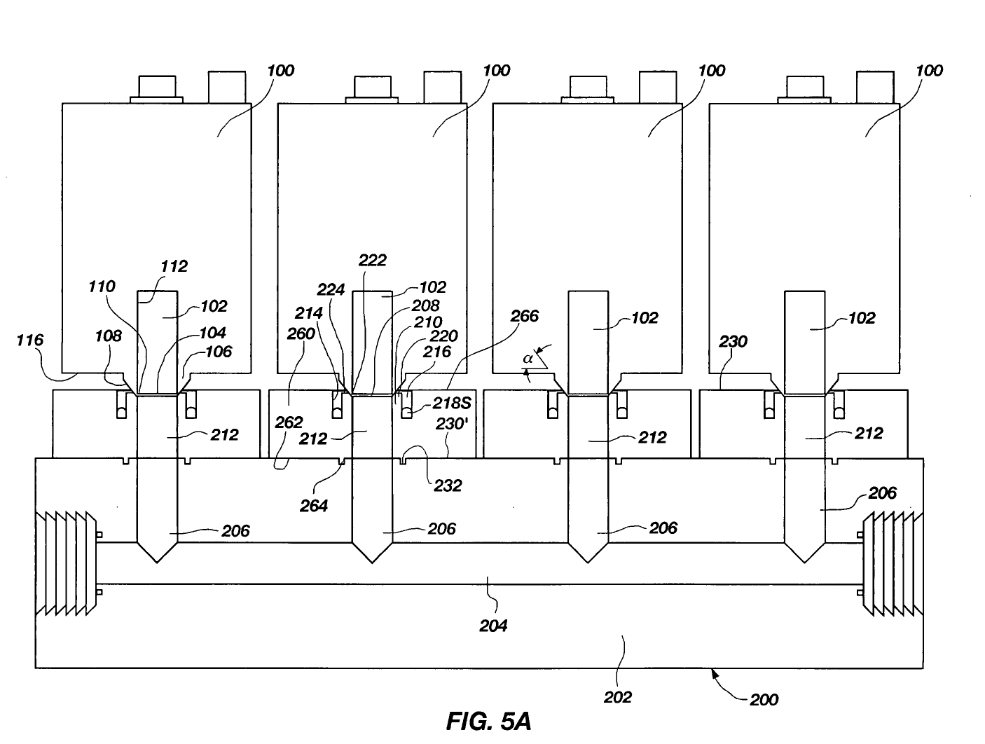

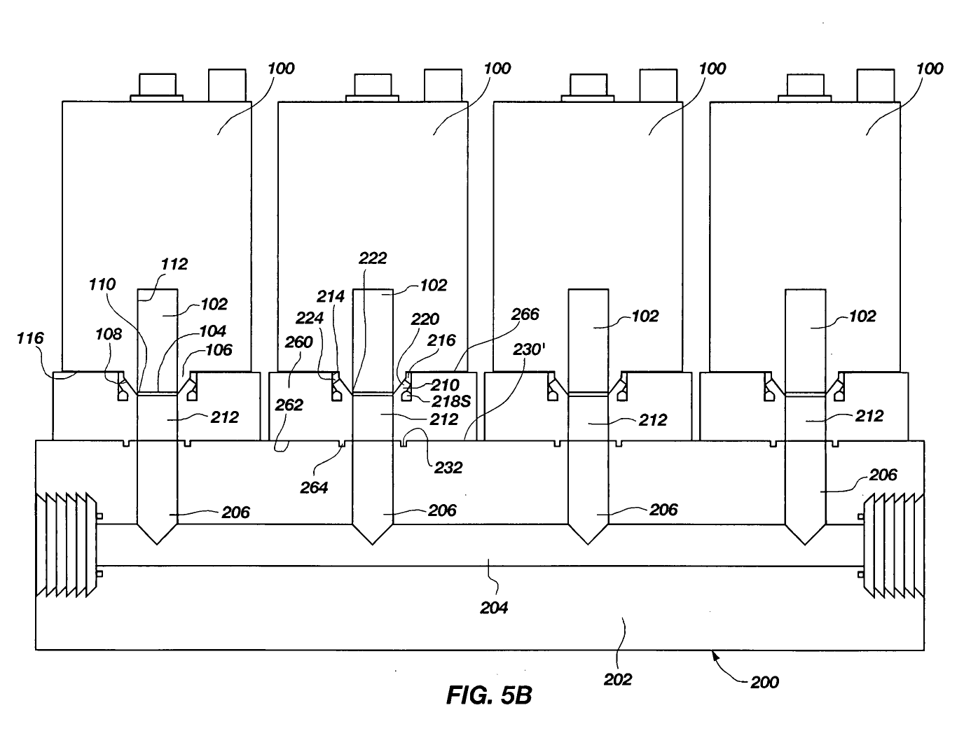

It should be noted that valve block 100 and manifold 200 may, conventionally, be forced toward one another by bolts extending through apertures in opposing corners of the valve block 100, which is typically of square transverse cross-section. In the foregoing embodiment, as well as those described and depicted herein with respect to FIGS. 2A through 4B and FIG. 10, the valve block 100 is secured directly to a manifold 200 of specific design according to the present invention. In the embodiments described and depicted herein with respect to FIGS. 5A through 9B, the use of various adapter structures as depicted and described facilitates the use of the present invention in conjunction with manifolds 200 of virtually any manufacturer and straightforward adaptation of such manifolds to the present invention.

A second embodiment of a coupling assembly according to the present invention is depicted in FIGS. 2A and 2B. A plurality of first components in the form of valve blocks 100 is shown disposed above (as the drawing sheet is oriented) a second component in the form of manifold 200.

Each valve block 100 (valve not shown for clarity) comprises a bore 102 extending thereinto and having a mouth 104 circumscribed by protruding annular nose portion 106. The nose portion 106 includes a frustoconical outer surface 108 tapering radially inwardly toward the distal end 110 thereof, terminating at a relatively sharp annular edge at the junction with bore wall 112, which junction may comprise a very small flat, chamfer or radius. By way of example only, bore 102 may be of a 0.25 inch diameter. Proximally behind frustoconical outer surface 108, cylindrical outer surface 114 extends to face surface 116 of valve block 100.

The manifold 200 includes a block 202 with a primary fluid flow path in the form of longitudinal bore 204 extending therethrough. Four (by way of example only) side, branch bores 206 extend from longitudinal bore 204. The upper end (as the drawing sheet is oriented) of each branch bore 206 terminates at a mouth 208 circumscribed by an annular skirt 210 extending coaxially about a longitudinal axis of branch bore 206 and defining an entry bore 212 of like diameter (e.g., 0.25 inch) to that of a bore 102 of a valve block 100, the annular skirt 210 having a radial wall thickness of, for the sake of example only, 0.060 inch. Annular skirt 210 is radially separated from a surrounding, annular coupling bore wall 214 of manifold 200 by an annular recess 216 therebetween. Unlike the first embodiment, however, there is no annular skirt compression adjustment ferrule. Further, annular recess 216 of the present embodiment has an annular bottom defining a concave, semicircular cross section which extends into annular skirt 210 at its radially inner extent and into annular coupling bore wall 214 at its outer extent. The distal end 220 of the annular skirt 210 may, optionally, comprise a chamfer or radius 222 at the junction of the skirt longitudinal end face 224 and the wall 226 of the entry bore 212 about which the annular skirt 210 extends. The chamfer angle α may approximate the angle of the frustoconical outer surface 108 of the first component. It should be noted at this point that an O-ring type ferrule 218o of circular transverse cross-section may, optionally, be disposed in the bottom of annular recess 216 to modify or control the deformation characteristics of annular skirt 210, as shown in broken lines at the left-hand annular recess 216 in FIG. 2A. The ferrule may be of the same, a similar, or a dissimilar material to that used in valve block 100 or manifold 200, and is formed separately therefrom.

In use and as shown in FIG. 2B, the protruding annular nose portion 106 of valve block 100 is inserted coaxially within the annular skirt 210 and the valve block 100 and manifold 200 forced toward one another along the aligned longitudinal axes of the two components until face surface 116 of valve block 100 from which protruding annular nose portion 106 extends lies proximate and, optionally, may abut face surface 230 of manifold 200 surrounding one of the annular recesses 216 encompassing annular skirt 210 defining entry bore 212. The protruding annular nose portion 106 of the valve block 100 inserted into annular skirt 210 of the manifold 200 spreads the annular skirt 210 radially outwardly as the inner surface of the annular skirt defining the wall 226 entry bore 212 sealingly conforms to the frustoconical outer surface 108 of the protruding annular nose portion 106 due to the resistance of the annular skirt 210 to deformation. As noted above, the resistance of the annular skirt 210 to deformation and, thus, the amount of force required to mate the nose portion 106 with skirt 210 and the tightness of the resulting seal therebetween may be set or adjusted by (in the absence of a skirt compression adjustment ferrule) the material characteristics of the skirt, the radial thickness thereof and the axial length thereof receiving the protruding nose portion.

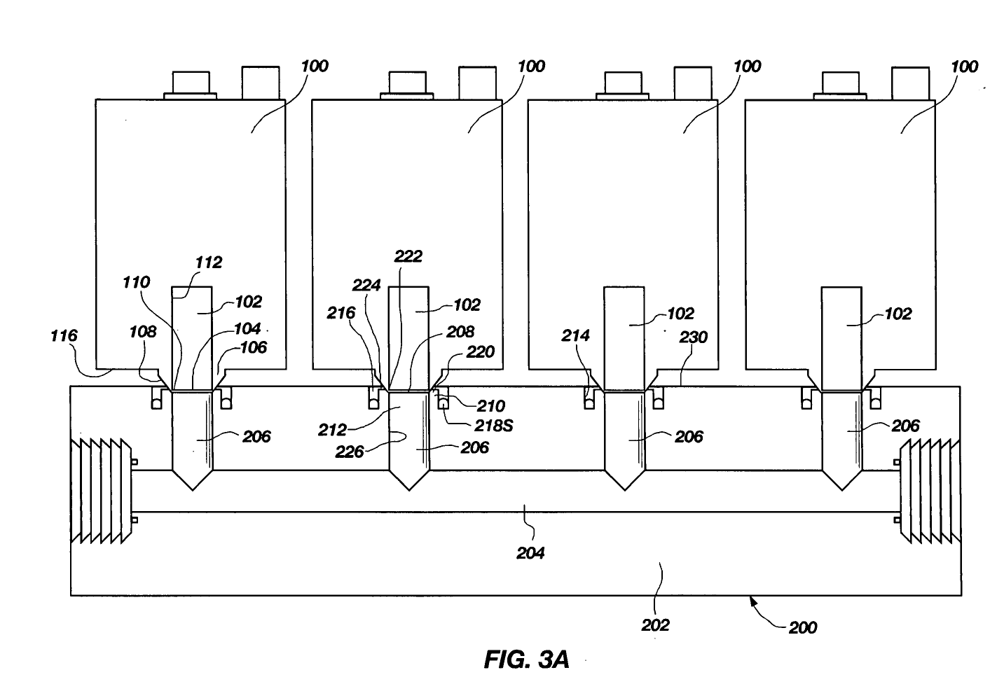

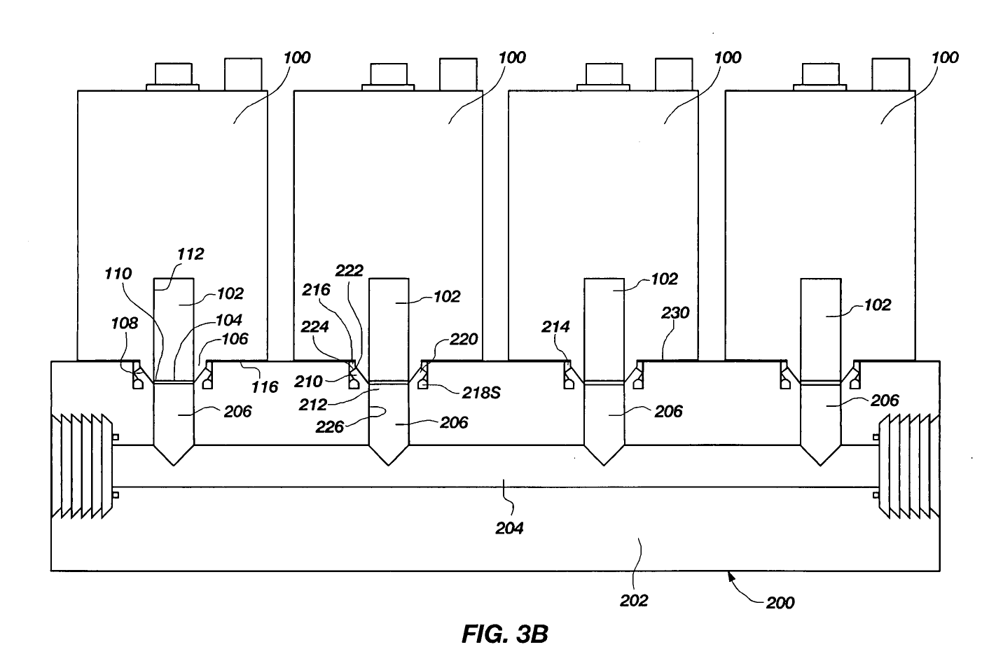

A third embodiment of a coupling assembly according to the present invention is depicted in FIGS. 3A and 3B. A plurality of first components in the form of valve blocks 100 is shown disposed above (as the drawing sheet is oriented) a second component in the form of manifold 200.

Each valve block 100 (valve not shown for clarity) comprises a bore 102 extending thereinto and having a mouth 104 circumscribed by protruding annular nose portion 106. The nose portion 106 includes a frustoconical outer surface 108 tapering radially inwardly toward the distal end 110 thereof, terminating at a relatively sharp annular edge at the junction with bore wall 112, which junction may comprise a very small flat, chamfer or radius. By way of example only, bore 102 may be of a 0.25 inch diameter. Proximally behind frustoconical outer surface 108, cylindrical outer surface 114 extends to face surface 116 of valve block 100.

The manifold 200 includes a block 202 with a primary fluid flow path in the form of longitudinal bore 204 extending therethrough. Four (by way of example only) side, branch bores 206 extend from longitudinal bore 204. The upper end (as the drawing sheet is oriented) of each branch bore 206 terminates at a mouth 208 circumscribed by an annular skirt 210 extending coaxially about a longitudinal axis of branch bore 206 and defining an entry bore 212 of like diameter (e.g., 0.25 inch) to that of a bore 102 of a valve block 100, the annular skirt 210 having a radial wall thickness of, for the sake of example only, 0.060 inch. Annular skirt 210 is radially separated from a surrounding, annular coupling bore wall 214 of manifold 200 by an annular recess 216 therebetween having a flat, annular bottom. At the bottom of the annular recess 216 is coaxially disposed an annular skirt compression adjustment ferrule 218s, which in this embodiment is formed separately from manifold 200 and is substantially of semicircular shape in transverse cross section but having sidewalls linearly extending from the respective ends of the semicircle and terminating at a flat underside disposed on the flat, annular bottom of annular recess 216. Skirt adjustment ferrule 218s may be of the same, a similar or a dissimilar material to that used in the valve block 100 or manifold 200. The distal end 220 of the annular skirt 210 may, optionally, comprise a chamfer 222 at the junction of the skirt longitudinal end face 224 and the wall 226 of the entry bore 212 about which the annular skirt 210 extends. The chamfer angle α may approximate the angle of the frustoconical outer surface 108 of the first component.

In use and as shown in FIG. 3B, the protruding annular nose portion 106 of valve block 100 is inserted coaxially within the annular skirt 210 and the valve block 100 and manifold 200 forced toward one another along the aligned longitudinal axes of the two components until face surface 116 of valve block 100 from which protruding annular nose portion 106 extends lies proximate or, optionally may abut face surface 230 of manifold 200 surrounding one of the annular recesses 216 encompassing annular skirt 210 defining entry bore 212. The protruding annular nose portion 106 of the valve block 100 inserted into the annular skirt of the manifold 200 spreads the annular skirt 210 radially outwardly as the inner surface of the annular skirt defining the bore wall 226 of entry bore 212 sealingly conforms to the frustoconical outer surface 108 of the protruding annular nose portion 106 due to the resistance of the annular skirt 210 to deformation. As noted above, the resistance of the annular skirt 210 to deformation and, thus, the amount of force required to mate the nose portion 106 with skirt 210 and the tightness of the resulting seal therebetween may be set or adjusted by the presence of annular skirt compression adjustment ferrule 218s (and the dimensions, cross-sectional shape and material thereof, the annular skirt compression adjustment ferrule of this embodiment being formed separately from manifold 200), in combination with the material characteristics of the skirt, the radial thickness thereof and the axial length thereof receiving the protruding nose portion. As may be appreciated by reference to FIG. 3B, the wall of annular skirt 210 is compressed radially between frustoconical outer surface 108 of nose portion 106 and the arcuate exterior surface of annular skirt compression ferrule 218, such compression resulting in a more robust engagement between bore wall 226 and frustoconical outer surface 108.

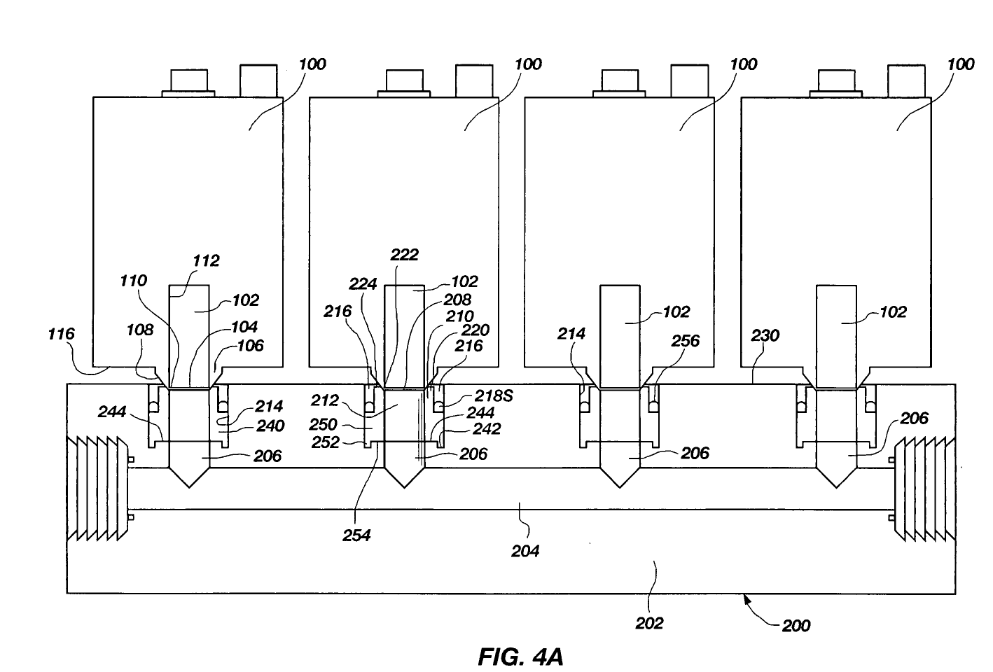

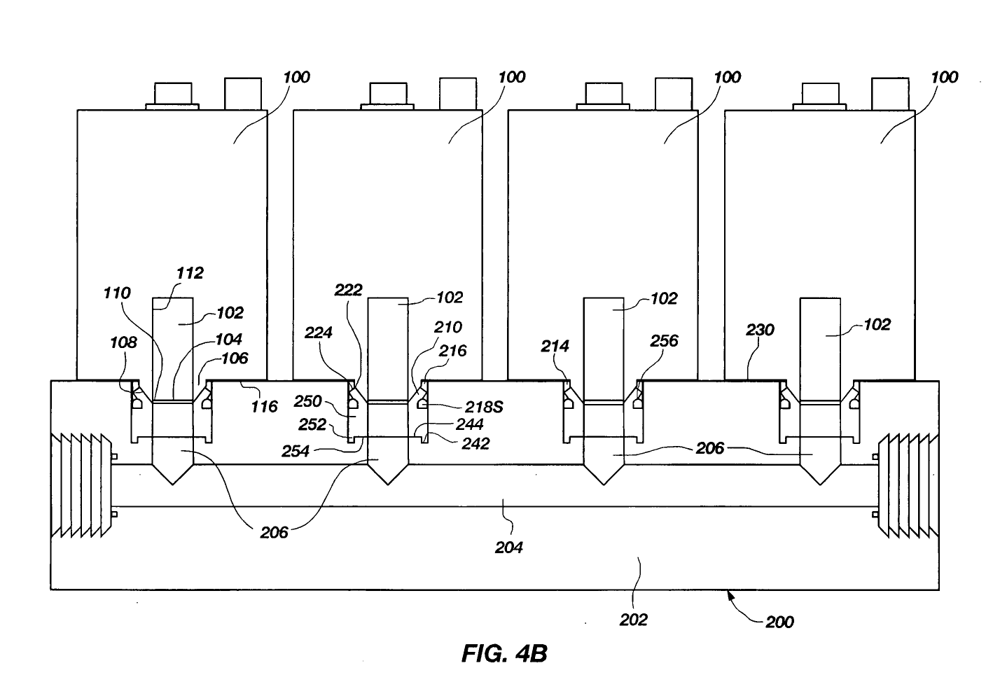

A fourth embodiment of a coupling assembly according to the present invention is depicted in FIGS. 4A and 4B. A plurality of first components in the form of valve blocks 100 is shown disposed above (as the drawing sheet is oriented) a second component in the form of manifold 200.

Each valve block 100 (valve not shown for clarity) comprises a bore 102 extending thereinto and having a mouth 104 circumscribed by protruding annular nose portion 106. The nose portion 106 includes a frustoconical outer surface 108 tapering radially inwardly toward the distal end 110 thereof, terminating at a relatively sharp annular edge at the junction with bore wall 112, which junction may comprise a very small flat, chamfer or radius. By way of example only, bore 102 may be of a 0.25 inch diameter. Proximally behind frustoconical outer surface 108, cylindrical outer surface 114 extends to face surface 116 of valve block 100.

The manifold 200 includes a block 202 with a primary fluid flow path in the form of longitudinal bore 204 extending therethrough. Four (by way of example only) side, branch bores 206 extend from longitudinal bore 204. Unlike in the previously described embodiments, however, each branch bore 206 is foreshortened and terminates at an adapter bore 240, the radially outer wall of which is defined by annular coupling bore wall 214, which extends to the bottom of annular recess 242 of rectangular cross section. Flat, annular bottom 244 of adapter bore 240 extends from annular recess 242 to the periphery of branch bore 206. Adapter 250 is disposed in adapter bore 240 and is dimensioned to provide an interference fit therewith, annular protrusion 252 being, as is conventional, of like dimensions to annular recess 242 and surrounding annular bottom 254 of adapter 250 which extends radially inwardly to entry bore 212, which in this embodiment extends through adapter 250. More specifically, adapter 250 per se need not provide an interference fit, it being sufficient that annular protrusion 252 be received in sealing, interfering engagement by annular recess 242. The upper end (as the drawing sheet is oriented) of the entry bore 212 terminates at a mouth 208 circumscribed by an annular skirt 210 formed as an integral part of adapter 250 and surrounding entry bore 212 of like diameter (e.g., 0.25 inch) to that of a bore 102 of a valve block 100, the annular skirt 210 having a radial wall thickness of, for the sake of example only, 0.060 inch. Annular skirt 210 is radially separated from the surrounding, annular coupling bore wall 214 of manifold 200 by an annular recess 216 therebetween having a flat, annular bottom provided by flat, annular top surface 256 of adapter 250 lying radially to the outside of annular skirt 210. At the bottom of the annular recess 216 and on top of flat, annular top surface 256 of adapter 250 is coaxially disposed an annular skirt compression adjustment ferrule 218s, which in this embodiment may be formed separately from manifold 200 and adapter 250 and is substantially of semicircular shape in transverse cross section but having sidewalls linearly extending from the respective ends of the semicircle and terminating at a flat underside disposed on the flat, annular bottom of annular recess 216. The distal end 220 of the annular skirt 210 may, optionally, comprise a chamfer or radius 222 at the junction of the skirt longitudinal end face 224 and the wall 226 of the entry bore 212 about which the annular skirt 210 extends. The chamfer angle α may approximate the angle of the frustoconical outer surface 108 of the first component.

In use and as shown in FIG. 4B, the protruding annular nose portion 106 of valve block 100 is inserted coaxially within the annular skirt 210 and the valve block 100 and manifold 200 forced toward one another along the aligned longitudinal axes of the two components until face surface 116 of valve block 100 from which protruding annular nose portion 106 extends lies proximate or, optionally, may abut face surface 230 of manifold 200 surrounding one of the annular recesses 216 encompassing annular skirt 210 defining entry bore 212. The protruding annular nose portion 106 of the valve block 100 inserted into the annular skirt of the adapter 250 spreads the annular skirt 210 radially outwardly as the inner surface of the annular skirt defining the bore wall 226 of entry bore 212 sealingly conforms to the frustoconical outer surface 108 of the protruding annular nose portion 106 due to the resistance of the annular skirt 210 to deformation. As noted above, the resistance of the annular skirt 210 to deformation and, thus, the amount of force required to mate the nose portion 106 with skirt 210 and the tightness of the resulting seal therebetween may be set or adjusted by the presence of annular skirt compression adjustment ferrule 218s (and the dimensions, cross-sectional shape and material thereof, the annular skirt compression adjustment ferrule of this embodiment being formed separately from manifold 200 and adapter 250), in combination with the material characteristics of the skirt, the radial thickness thereof and the axial length thereof receiving the protruding nose portion. As may be appreciated by reference to FIG. 4B, the wall of annular skirt 210 is compressed radially between frustoconical outer surface 108 of nose portion 106 and the arcuate exterior surface of annular skirt compression ferrule 218s, such compression resulting in a more robust engagement between bore wall 226 and frustoconical outer surface 108.

A fifth embodiment of a coupling assembly according to the present invention is depicted in FIGS. 5A and 5B. A plurality of first components in the form of valve blocks 100 is shown disposed above (as the drawing sheet is oriented) a second component in the form of manifold 200.

Each valve block 100 (valve not shown for clarity) comprises a bore 102 extending thereinto and having a mouth 104 circumscribed by protruding annular nose portion 106. The nose portion 106 includes a frustoconical outer surface 108 tapering radially inwardly toward the distal end 110 thereof, terminating at a relatively sharp annular edge at the junction with bore wall 112, which junction may comprise a very small flat, chamfer or radius. By way of example only, bore 102 may be of a 0.25 inch diameter. Proximally behind frustoconical outer surface 108, cylindrical outer surface 114 extends to face surface 116 of valve block 100.

The manifold 200 includes a block 202 with a primary fluid flow path in the form of longitudinal bore 204 extending therethrough. Four (by way of example only) side, branch bores 206 extend from longitudinal bore 204. As with the preceding embodiment, each branch bore 206 may be foreshortened, but instead of terminating at an adapter bore, each branch bore 206 terminates at a face surface 230′ of manifold 200. Adapter block 260 is supported on face surface 230′, the lower surface 262 of adapter block 260 being flat, but for the presence of annular protrusion 264 of substantially rectangular cross-section which extends into a similarly dimensioned annular recess 232 in face surface 230′ in an interference fit which provides a conventional tongue and groove type seal. Adapter block 260 may be secured to manifold 200 by suitable fastening structure as known in the art, such as, for example, screws, bolts or clamps (not shown), which may be the same bolts used to secure valve block 100 to manifold 200, passing through adapter block 260. Adapter block 260 further comprises entry bore 212 extending therethrough of like diameter (e.g., 0.25 inch) to that of a bore 102 of a valve block 100. The upper end (as the drawing sheet is oriented) of the entry bore 212 terminates at a mouth 208 circumscribed by an annular skirt 210 formed as an integral part of adapter block 260 and surrounding entry bore 212. Annular skirt 210 is radially separated from a surrounding, annular coupling bore wall 214 of adapter block 260 by an annular recess 216 therebetween having a flat, annular bottom lying radially to the outside of annular skirt 210. On the bottom of the annular recess 216 is coaxially disposed an annular skirt compression adjustment ferrule 218s, which in this embodiment is formed separately from manifold 200 and adapter block 260 and is substantially of semicircular shape in transverse cross section but having sidewalls linearly extending from the respective ends of the semicircle and terminating at a flat underside disposed on the flat, annular bottom of annular recess 216. The distal end 220 of the annular skirt 210 may, optionally, comprise a chamfer or radius 222 at the junction of the skirt longitudinal end face 224 and the wall 226 of the entry bore 212 about which the annular skirt 210 extends. The chamfer angle α may approximate the angle of the frustoconical outer surface 108 of the first component. Surrounding annular recess 216 is face surface 266.

In use and as shown in FIG. 5B, the protruding annular nose portion 106 of valve block 100 is inserted coaxially within the annular skirt 210 and the valve block 100 and manifold 200 are forced toward one another along the aligned longitudinal axes of the two components until face surface 116 of valve block 100 from which protruding annular nose portion 106 extends lies proximate or, optionally, may abut face surface 266 of adapter block 260 surrounding annular recess 216 encompassing annular skirt 210 defining entry bore 212. The protruding annular nose portion 106 of the valve block 100 inserted into the annular skirt of the adapter block 260 spreads the annular skirt 210 radially outwardly as the inner surface of the annular skirt 210 defining the bore wall 226 of entry bore 212 sealingly conforms to the frustoconical outer surface 108 of the protruding annular nose portion 106 due to the resistance of the annular skirt 210 to deformation. As noted above, the resistance of the annular skirt 210 to deformation and, thus, the amount of force required to mate the nose portion 106 with skirt 210 and the tightness of the resulting seal therebetween may be set or adjusted by the presence of annular skirt compression adjustment ferrule 218s (and the dimensions, cross-sectional shape and material thereof, the annular skirt compression adjustment ferrule of this embodiment being formed separately from manifold 200 and adapter block 260), in combination with the material characteristics of the skirt, the radial thickness thereof and the axial length thereof receiving the protruding nose portion. As may be appreciated by reference to FIG. 5B, the wall of annular skirt 210 is compressed radially between frustoconical outer surface 108 of nose portion 106 and the arcuate exterior surface of annular skirt compression ferrule 218s, such compression resulting in a more robust engagement between bore wall 226 and frustoconical outer surface 108.

In the embodiment of FIGS. 5A and 5B, it should be noted that adapter block 260 is of square transverse cross-sectional configuration and of like lateral dimensions to valve block 100, which is also square. Bolts extending through apertures in opposing corners of valve block 100 also extend through aligned apertures in adapter block 260 and into threaded bores of manifold 200. When the bolts are made up, valve block 100 is drawn toward manifold 200 with adapter block 260 compressed therebetween.

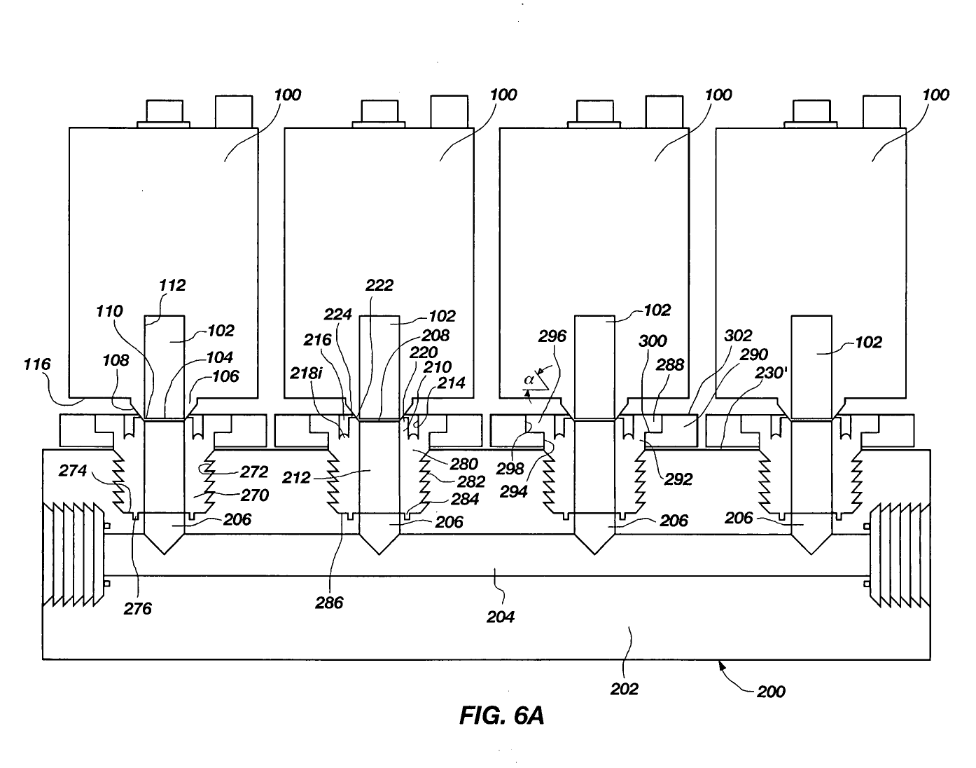

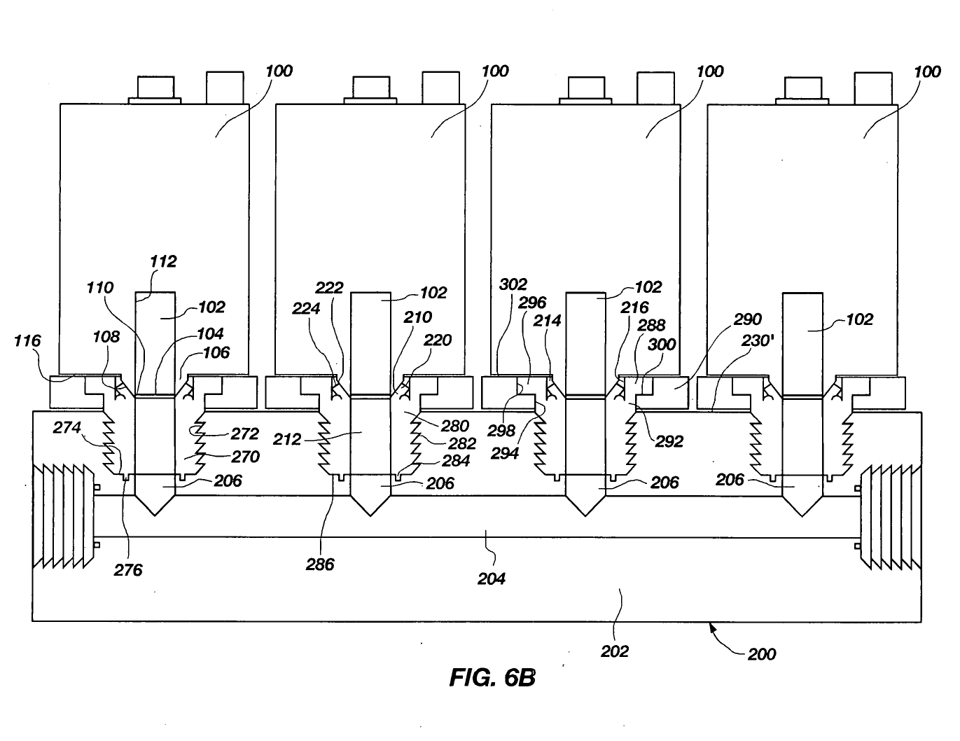

A sixth embodiment of a coupling assembly according to the present invention is depicted in FIGS. 6A and 6B. A plurality of first components in the form of valve blocks 100 is shown disposed above (as the drawing sheet is oriented) a second component in the form of manifold 200.

Each valve block 100 (valve not shown for clarity) comprises a bore 102 extending thereinto and having a mouth 104 circumscribed by protruding annular nose portion 106. The nose portion 106 includes a frustoconical outer surface 108 tapering radially inwardly toward the distal end 110 thereof, terminating at a relatively sharp annular edge at the junction with bore wall 112, which junction may comprise a very small flat, chamfer or radius. By way of example only, bore 102 may be of a 0.25 inch diameter. Proximally behind frustoconical outer surface 108, cylindrical outer surface 114 extends to face surface 116 of valve block 100.

The manifold 200 includes a block 202 with a primary fluid flow path in the form of longitudinal bore 204 extending therethrough. Four (by way of example only) side, branch bores 206 extend from longitudinal bore 204. Each branch bore 206 is foreshortened and terminates at an adapter bore 270 in face surface 230′, the radially outer wall of adapter bore 70 being defined by threaded annular coupling bore wall 272, which extends to the bottom of adapter bore 270 which, in turn, extends from threaded annular coupling bore wall 272 to the periphery of branch bore 206 and comprises flat bottom 274 having annular recess 276 of rectangular cross section extending downwardly therefrom into manifold 200. Adapter 280 having threaded exterior surface 282 is disposed in adapter bore 270 in threaded engagement with threaded annular coupling bore wall 272, and includes annular protrusion 284 on the flat, annular bottom 286 thereof which is received in sealing engagement by annular recess 276 and is dimensioned to provide an interference fit therewith, as is conventional. Flat, annular bottom 286 of adapter 280 extends radially inwardly to the periphery of entry bore 212, which in this embodiment extends through adapter 280. The upper end (as the drawing sheet is oriented) of the entry bore 212 terminates at a mouth 208 circumscribed by an annular skirt 210 formed as an integral part of adapter 280 and surrounding entry bore 212 of like diameter (e.g., 0.25 inch) to that of a bore 102 of a valve block 100, the annular skirt 210 having a radial wall thickness of, for the sake of example only, 0.060 inch. Annular skirt 210 is radially separated from the surrounding, annular coupling bore wall 214 of adapter 280 by an annular recess 216 therebetween having an annular bottom configured as an integral, annular skirt compression ferrule 218i lying radially to the outside of annular skirt 210 and substantially of semicircular shape in transverse cross section. The distal end 220 of the annular skirt 210 may, optionally, comprise a chamfer or radius 222 at the junction of the skirt longitudinal end face 224 and the wall 226 of the entry bore 212 about which the annular skirt 210 extends. The chamfer angle α may approximate the angle of the frustoconical outer surface 108 of the first component. The top of adapter 280 comprises an annular flange 288. Adapter block 290 is disposed about adapter 280 and resides on top of face surface 230′ of manifold 200, adapter block 290 comprising a first, lower bore 292 defined by bore wall 294 and a second, upper counterbore 296 defined by bore wall 298. Adapter block 290 may be secured to face surface 230′ of manifold 200 by suitable fastening structure as known in the art, such as bolts, screws, clamps, etc. (not shown) or may merely be maintained in place by engagement of adapter 280 with manifold 200. When adapter 280 is threaded into adapter bore 270, annular flange 288 is received in counterbore 296, and lies adjacent the lower surface 300 thereof, providing a seal. The upper surface of annular flange 288 then lies substantially flush with face surface 302 of adapter block 290.

In use and as shown in FIG. 6B, the protruding annular nose portion 106 of valve block 100 is inserted coaxially within the annular skirt 210 and the valve block 100 and manifold 200 are forced toward one another along the aligned longitudinal axes of the two components until face surface 116 of valve block 100 from which protruding annular nose portion 106 extends abuts face surface 302 of adapter block 290. The protruding annular nose portion 106 of the valve block 100 inserted into the annular skirt 210 of the adapter 280 spreads the annular skirt 210 radially outwardly as the inner surface of the annular skirt defining the bore wall 226 of entry bore 212 sealingly conforms to the frustoconical outer surface 108 of the protruding annular nose portion 106 due to the resistance of the annular skirt 210 to deformation. As noted above, the resistance of the annular skirt 210 to deformation and, thus, the amount of force required to mate the nose portion 106 with skirt 210 and the tightness of the resulting seal therebetween may be set or adjusted by the presence of annular skirt compression adjustment ferrule 218i (and the dimensions and cross-sectional shape thereof, the annular skirt compression adjustment ferrule of this embodiment being formed integrally with adapter 280), in combination with the material characteristics of the skirt, the radial thickness thereof and the axial length thereof receiving the protruding nose portion. As may be appreciated by reference to FIG. 6B, the wall of annular skirt 210 is compressed radially between frustoconical outer surface 108 of nose portion 106 and the arcuate exterior surface of annular skirt compression ferrule 218s, such compression resulting in a more robust engagement between bore wall 226 and frustoconical outer surface 108.

In the embodiment of FIGS. 6A and 6B, it should be noted that adapter block 290 is of square transverse cross-section and of like lateral dimension to valve block 100, which is also square. Lower bore 292 and counterbore 296 of adapter 280 are substantially cylindrical, as are the exterior of adapter 280 above threaded exterior surface 282 and annular flange 288, so that adapter 280 may be rotated within adapter block 290 as adapter 280 is threaded into adapter bore 270 of manifold 200. Valve block 100 may be secured to manifold 100, as previously described, through use of bolts extending through apertures in opposing corners of valve block 100 and aligned apertures in like corners of adapter block 290, distal ends of the bolts being made up with aligned, threaded bores in manifold 200.

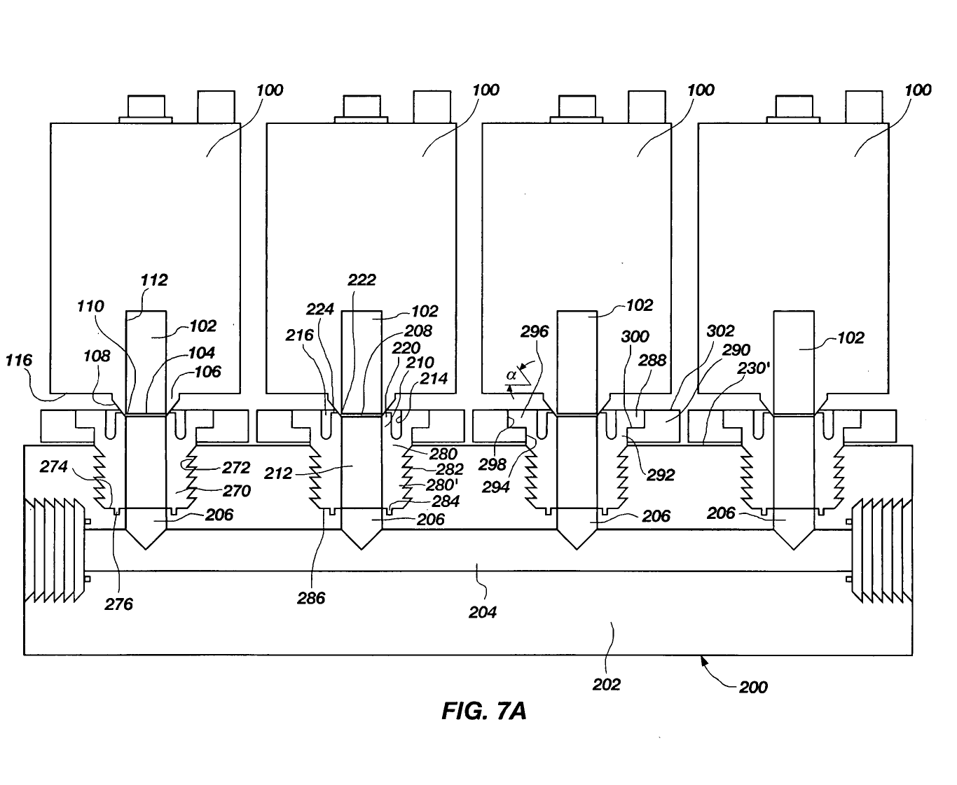

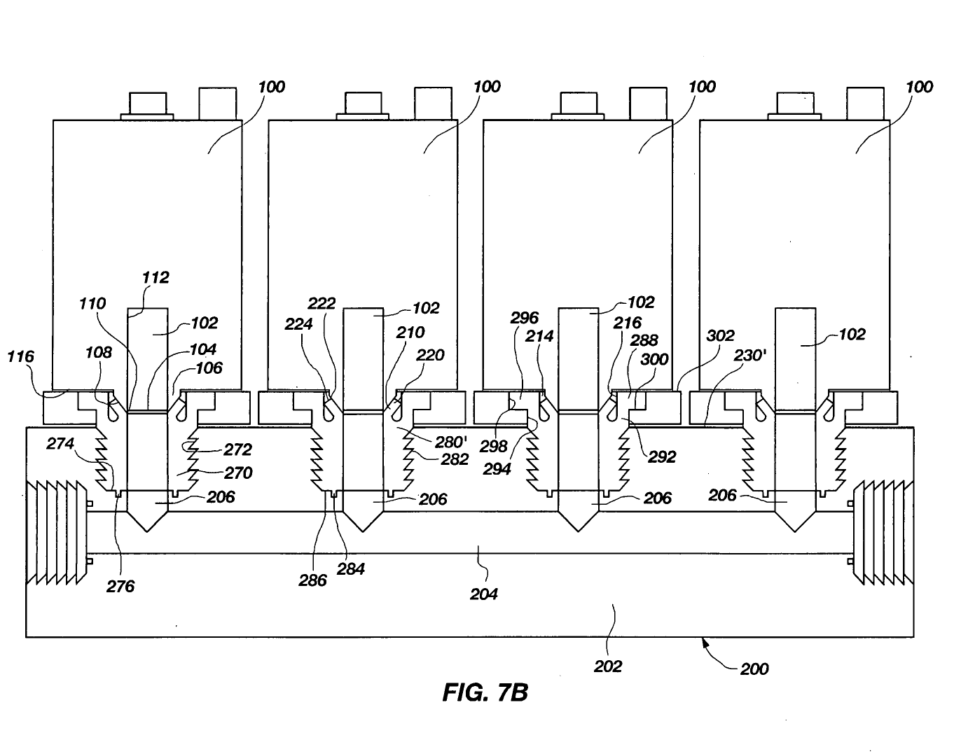

A seventh embodiment of a coupling assembly according to the present invention is depicted in FIGS. 7A and 7B. A plurality of first components in the form of valve blocks 100 is shown disposed above (as the drawing sheet is oriented) a second component in the form of manifold 200.

Each valve block 100 (valve not shown for clarity) comprises a bore 102 extending thereinto and having a mouth 104 circumscribed by protruding annular nose portion 106. The nose portion 106 includes a frustoconical outer surface 108 tapering radially inwardly toward the distal end 110 thereof, terminating at a relatively sharp annular edge at the junction with bore wall 112, which junction may comprise a very small flat, chamfer or radius. By way of example only, bore 102 may be of a 0.25 inch diameter. Proximally behind frustoconical outer surface 108, cylindrical outer surface 114 extends to face surface 116 of valve block 100.

The manifold 200 includes a block 202 with a primary fluid flow path in the form of longitudinal bore 204 extending therethrough. Four (by way of example only) side, branch bores 206 extend from longitudinal bore 204. Each branch bore 206 is foreshortened and terminates at an adapter bore 270 in face surface 230′, the radially outer wall of adapter bore 270 being defined by threaded annular coupling bore wall 272, which extends to the bottom of adapter bore 270 which, in turn, extends from threaded annular coupling bore wall 272 to the periphery of branch bore 206 and comprises flat bottom 274 having annular recess 276 of substantially rectangular cross section extending downwardly therefrom into manifold 200. Adapter 280′ having threaded exterior surface 282 is disposed in adapter bore 270 in threaded engagement with annular coupling bore wall 272, and includes annular protrusion 284 on the flat, annular bottom 286 thereof which is received in sealing engagement by annular recess 276 and is dimensioned to provide an interference fit therewith, as is conventional. Flat, annular bottom 286 of adapter 280′ extends radially inwardly to the periphery of entry bore 212, which in this embodiment extends through adapter 280′. The upper end (as the drawing sheet is oriented) of the entry bore 212 terminates at a mouth 208 circumscribed by an annular skirt 210 formed as an integral part of adapter 280′ and surrounding entry bore 212 of like diameter (e.g., 0.25 inch) to that of a bore 102 of a valve block 100, the annular skirt 210 having a radial wall thickness of, for the sake of example only, 0.060 inch. Annular skirt 210 is radially separated from the surrounding, annular coupling bore wall 214 of manifold 200 by an annular recess 216 therebetween having an annular, concave bottom of substantially semicircular cross section lying radially to the outside of annular skirt 210. It should be noted at this point that an O-ring type ferrule of circular transverse cross-section may, optionally, be disposed in the bottom of annular recess 216 to modify or control the deformation characteristics of annular skirt 210. The distal end 220 of the annular skirt 210 may, optionally, comprise a chamfer or radius 222 at the junction of the skirt longitudinal end face 224 and the wall 226 of the entry bore 212 about which the annular skirt 210 extends. The chamfer angle α may approximate the angle of the frustoconical outer surface 108 of the nose portion 106. The top of adapter 280′ comprises an annular flange 288. Adapter block 290 is disposed about adapter 280′ and resides on top of face surface 230′ of manifold 200, adapter block 290 comprising a first, lower bore 292 defined by bore wall 294 and a second, upper counterbore 296 defined by bore wall 298. Adapter block 290 may be secured to face surface 230′ of manifold 200 by suitable fastening structure as known in the art, such as bolts, screws, clamps, etc. (not shown) or, for example, valve block 100 may be threaded to the adapter block 290. When adapter 280′ is threaded into adapter bore 270, annular flange 288 is received in counterbore 296, and lies adjacent the lower surface 300 thereof. The upper surface of annular flange 288 then lies substantially flush with face surface 302 of adapter block 290.

In use and as shown in FIG. 7B, the protruding annular nose portion 106 of valve block 100 is inserted coaxially within the annular skirt 210 and the valve block 100 and manifold 200 forced toward one another along the aligned longitudinal axes of the two components until face surface 116 of valve block 100 from which protruding annular nose portion 106 extends abuts face surface 302 of adapter block 290. The protruding annular nose portion 106 of the valve block 100 inserted into the annular skirt 210 of the adapter 280′ spreads the annular skirt 210 radially outwardly as the inner surface of the annular skirt 210 defining the bore wall 226 of entry bore 212 sealingly conforms to the frustoconical outer surface 108 of the protruding annular nose portion 106 due to the resistance of the annular skirt 210 to deformation. As noted above, the resistance of the annular skirt 210 to deformation and, thus, the amount of force required to mate the nose portion 106 with skirt 210 and the tightness of the resulting seal therebetween may be set or adjusted by the material characteristics of the skirt, the radial thickness thereof and the axial length thereof receiving the protruding nose portion 106.

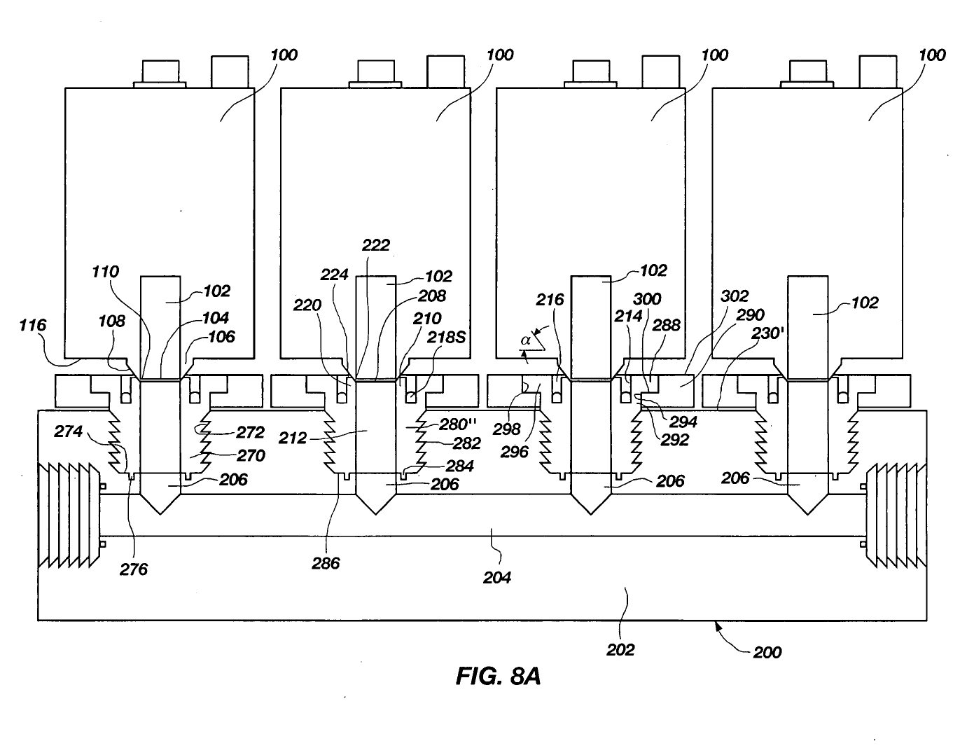

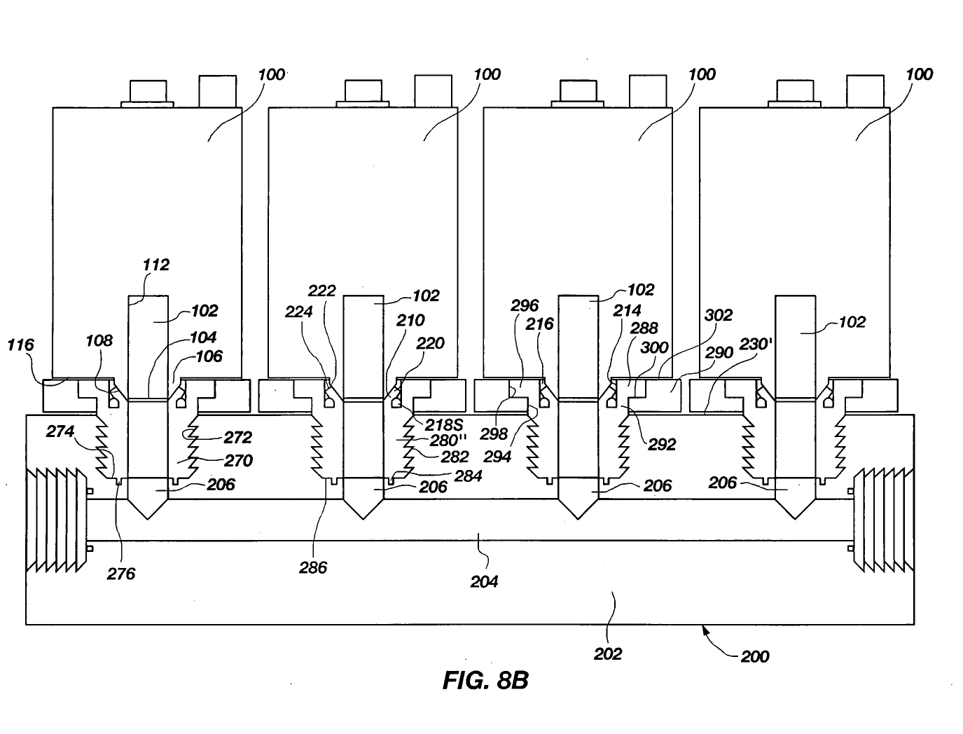

An eighth embodiment of a coupling assembly according to the present invention is depicted in FIGS. 8A and 8B. A plurality of first components in the form of valve blocks 100 is shown disposed above (as the drawing sheet is oriented) a second component in the form of manifold 200.

Each valve block 100 (valve not shown for clarity) comprises a bore 102 extending thereinto and having a mouth 104 circumscribed by protruding annular nose portion 106. The nose portion 106 includes a frustoconical outer surface 108 tapering radially inwardly toward the distal end 110 thereof, terminating at a relatively sharp annular edge at the junction with bore wall 112, which junction may comprise a very small flat, chamfer or radius. By way of example only, bore 102 may be of a 0.25 inch diameter. Proximally behind frustoconical outer surface 108, cylindrical outer surface 114 extends to face surface 116 of valve block 100.

The manifold 200 includes a block 202 with a primary fluid flow path in the form of longitudinal bore 204 extending therethrough. Four (by way of example only) side, branch bores 206 extend from longitudinal bore 204. Each branch bore 206 is foreshortened and terminates at an adapter bore 270 in face surface 230′, the radially outer wall of adapter bore 270 being defined by threaded annular coupling bore wall 272, which extends to the bottom of adapter bore 270 which, in turn, extends from threaded annular coupling bore wall 272 to the periphery of branch bore 206 and comprises flat bottom 274 having annular recess 276 of rectangular cross section extending downwardly therefrom into manifold 200. Adapter 280″ having threaded exterior surface 282 is disposed in adapter bore 270 in threaded engagement with annular coupling bore wall 272, and includes annular protrusion 284 on the flat, annular bottom 286 thereof which is received in sealing engagement by annular recess 276 and is dimensioned to provide an interference fit therewith, as is conventional. Flat, annular bottom 286 of adapter 280″ extends radially inwardly to the periphery of entry bore 212, which in this embodiment extends through adapter 280. The upper end (as the drawing sheet is oriented) of the entry bore 212 terminates at a mouth 208 circumscribed by an annular skirt 210 formed as an integral part of adapter 280″ and surrounding entry bore 212 of like diameter (e.g., 0.25 inch) to that of a bore 102 of a valve block 100, the annular skirt 210 having a radial wall thickness of, for the sake of example only, 0.060 inch. Annular skirt 210 is radially separated from the surrounding annular coupling bore wall 214 of manifold 200 by an annular recess 216 therebetween having a flat, annular bottom lying radially to the outside of annular skirt 210. On the bottom of the annular recess 216 is coaxially disposed an annular skirt compression adjustment ferrule 218s, which in this embodiment is formed separately from manifold 200 and adapter 260 and is substantially of semicircular shape in transverse cross section but having sidewalls linearly extending from the respective ends of the semicircle and terminating at a flat underside disposed on the flat, annular bottom of annular recess 216. The distal end 220 of the annular skirt 210 may, optionally, comprise a chamfer or radius 222 at the junction of the skirt longitudinal end face 224 and the wall 226 of the entry bore 212 about which the annular skirt 210 extends. The chamfer angle α may approximate the angle of the frustoconical outer surface 108 of the first component. The top of adapter 280 comprises an annular flange 288. Adapter block 290 is disposed about adapter 280″ and resides on top of face surface 230′ of manifold 200, adapter block 290 comprising a first, lower bore 292 defined by bore wall 294 and a second, upper counterbore 296 defined by bore wall 298. Adapter block 290 may be secured to face surface 230′ of manifold 200 by suitable fastening structure as known in the art, such as bolts, screws, clamps, etc. (not shown) or, for example, valve block 100 may be threaded to adapter block 290. When adapter 280″ is threaded into adapter bore 270, annular flange 288 is received in counterbore 296 adjacent the lower surface 300. The upper surface of annular flange 288 then lies substantially flush with face surface 302 of adapter block 290.

In use and as shown in FIG. 8B, the protruding annular nose portion 106 of valve block 100 is inserted coaxially within the annular skirt 210 and the valve block 100 and manifold 200 are forced toward one another along the aligned longitudinal axes of the two components until face surface 116 of valve block 100 from which protruding annular nose portion 106 extends abuts face surface 302 of adapter block 290. The protruding annular nose portion 106 of the valve block 100 inserted into the annular skirt 210 of the adapter 280″ spreads the annular skirt 210 radially outwardly as the inner surface of the annular skirt defining the bore wall 226 of entry bore 212 sealingly conforms to the frustoconical outer surface 108 of the protruding annular nose portion 106 due to the resistance of the annular skirt 210 to deformation. As noted above, the resistance of the annular skirt 210 to deformation and, thus, the amount of force required to mate the nose portion 106 with skirt 210 and the tightness of the resulting seal therebetween may be set or adjusted by the presence of annular skirt compression adjustment ferrule 218s (and the dimensions, cross-sectional shape and material thereof, the annular skirt compression adjustment ferrule of this embodiment being formed separately from adapter 280″), in combination with the material characteristics of the skirt, the radial thickness thereof and the axial length thereof receiving the protruding nose portion 106. As may be appreciated by reference to FIG. 8B, the wall of annular skirt 210 is compressed radially between frustoconical outer surface 108 of nose portion 106 and the arcuate exterior surface of annular skirt compression ferrule 218s, such compression resulting in a more robust engagement between bore wall 226 and frustoconical outer surface 108.

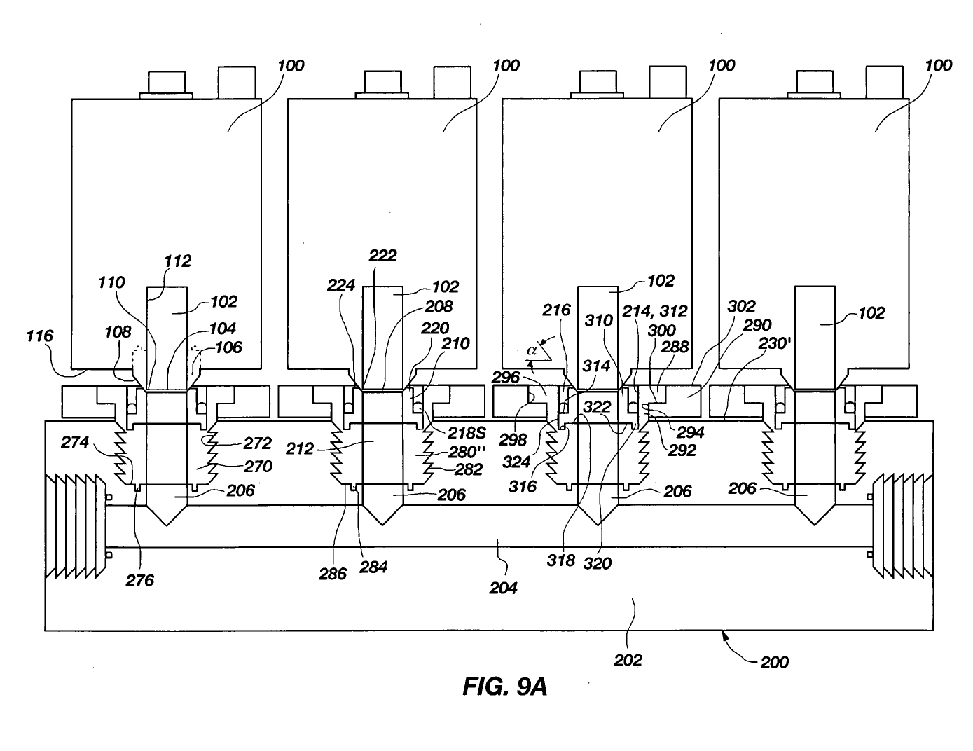

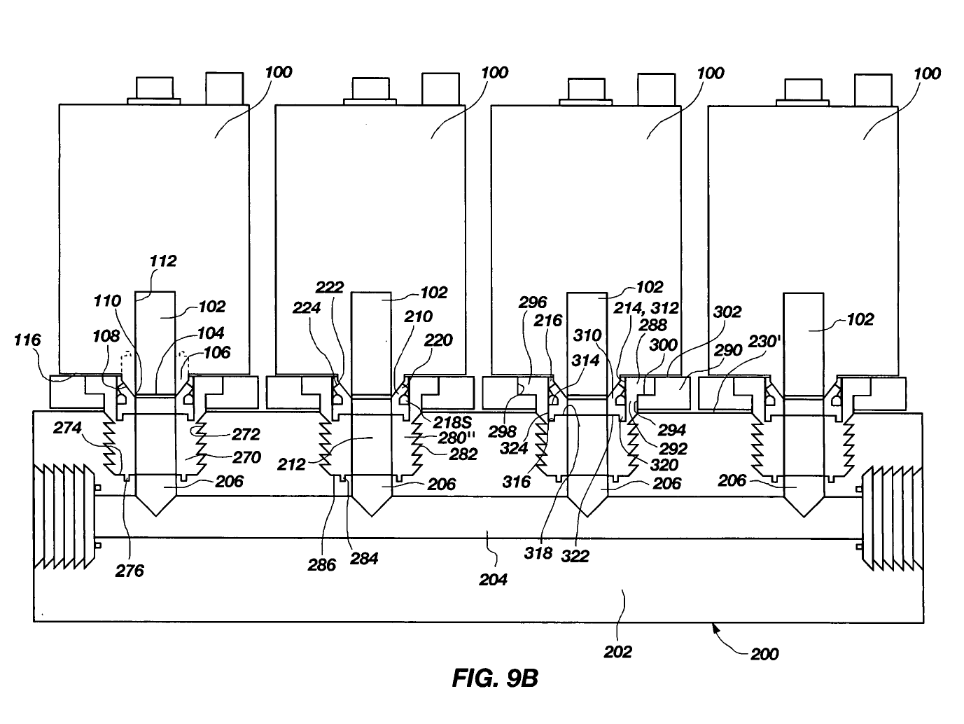

A ninth embodiment of a coupling assembly according to the present invention is depicted in FIGS. 9A and 9B. A plurality of first components in the form of valve blocks 100 is shown disposed above (as the drawing sheet is oriented) a second component in the form of manifold 200.

Each valve block 100 (valve not shown for clarity) comprises a bore 102 extending thereinto and having a mouth 104 circumscribed by protruding annular nose portion 106. The nose portion 106 includes a frustoconical outer surface 108 tapering or radially inwardly toward the distal end 110 thereof, terminating at a relatively sharp annular edge at the junction with bore wall 112, which junction may comprise a very small flat, chamfer or radius. By way of example only, bore 102 may be of a 0.25 inch diameter. Proximally behind frustoconical outer surface 108, cylindrical outer surface 114 extends to face surface 116 of valve block 100.

The manifold 200 includes a block 202 with a primary fluid flow path in the form of longitudinal bore 204 extending therethrough. Four (by way of example only) side, branch bores 206 extend from longitudinal bore 204. Each branch bore 206 is foreshortened and terminates at an adapter bore 270 in face surface 230′, the radially outer wall of adapter bore 270 being defined by threaded annular coupling bore wall 272, which extends to the bottom of adapter bore 270 which, in turn, extends from threaded annular coupling bore wall 272 to the periphery of branch bore 206 and comprises flat bottom 274 having annular recess 276 of rectangular cross section extending downwardly therefrom into manifold 200. Adapter 280″ is very similar in overall structure to adapter 280″ of the previous embodiment, having threaded exterior surface 282 is disposed in adapter bore 270 in threaded engagement with annular coupling bore wall 272, and includes annular protrusion 284 on the flat, annular bottom 286 thereof which is received in sealing engagement by annular recess 276 and is dimensioned to provide an interference fit therewith, as is conventional. Flat, annular bottom 286 of adapter 280″ extends radially inwardly to the periphery of entry bore 212, which in this embodiment extends through adapter 280″ and adapter insert 310 received therein. The upper end (as the drawing sheet is oriented) of the entry bore 212 terminates at a mouth 208 circumscribed by an annular skirt 210 formed as part of adapter insert 310 for use in adapter 280″ and surrounding entry bore 212 of like diameter (e.g., 0.25 inch) to that of a bore 102 of a valve block 100, the annular skirt 210 having a radial wall thickness of, for the sake of example only, 0.060 inch. As in the previous embodiment, annular skirt 210 is radially separated from the surrounding, annular coupling bore wall 214 comprising insert bore wall 312 of adapter 280″ by an annular recess 216 therebetween having a flat, annular bottom lying radially to the outside of annular skirt 210. On the bottom of the annular recess 216 is coaxially disposed an annular skirt compression adjustment ferrule 218s, which in this embodiment is formed separately from adapter 280″ and adapter insert 310 and is substantially of semicircular shape in transverse cross section but having sidewalls linearly extending from the respective ends of the semicircle and terminating at a flat underside disposed on the flat, annular bottom of annular recess 216. However, unlike in the previous embodiment, annular recess 216 is defined between an insert bore wall 312 of adapter 280″, a flat annular bottom defined by insert shoulder 314 and the exterior of annular skirt 210. Insert bore wall 312 of adapter 280″ extends downwardly to annular recess 316 of substantially rectangular cross section, radially inwardly of which lies flat insert bore bottom 318 surrounding the periphery of entry bore 212. The underside of adapter insert 310 comprises annular protrusion 320, which is of like shape and dimensions to annular recess 316 and sealingly engages therewith. Flat, annular bottom 322 of adapter insert 310 extends radially inwardly of annular protrusion to entry bore 212, annular skirt 210 extending upwardly therefrom. Outer circumferential surface 324 of adapter insert 310 fits snugly within insert bore wall 312 of adapter 280″. The distal end 220 of the annular skirt 210 may, optionally, comprise a chamfer or radius 222 at the junction of the skirt longitudinal end face 224 and the wall 226 of the entry bore 212 about which the annular skirt 210 extends. The chamfer angle α may approximate the angle of the frustoconical outer surface 108 of the first component. The top of adapter 280″ comprises an annular flange 288. Adapter block 290 is disposed about adapter 280″ and resides on top of face surface 230′ of manifold 200, adapter block 290 comprising a first, lower bore 292 defined by bore wall 294 and a second, upper counterbore 296 defined by bore wall 298. Adapter block 290 may be secured to face surface 230′ of manifold 200 by suitable fastening structure as known in the art, such as bolts, screws, clamps, etc. (not shown) or, for example, valve block 100 may be threaded to adapter block 290. When adapter 280″ is threaded into adapter bore 270, annular flange 288 is received in counterbore 296, the lower surface 300 thereof providing a positive stop to the depth of insertion of adapter 280″ in adapter bore 270. The upper surface of annular flange 288 then lies substantially flush with face surface 302 of adapter block 290.

In use and as shown in FIG. 9B, the protruding annular nose portion 106 of valve block 100 is inserted coaxially within the annular skirt 210 and the valve block 100 and manifold 200 are forced toward one another along the aligned longitudinal axes of the two components until face surface 116 of valve block 100 from which protruding annular nose portion 106 extends lies proximate or, optionally, may abut face surface 302 of adapter block 290. The protruding annular nose portion 106 of the valve block 100 inserted into the annular skirt of the adapter 280″ spreads the annular skirt 210 radially outwardly as the inner surface of the annular skirt defining the bore wall 226 of entry bore 212 sealingly conforms to the frustoconical outer surface 108 of the protruding annular nose portion 106 due to the resistance of the annular skirt 210 to deformation. As noted above, the resistance of the annular skirt 210 to deformation and, thus, the amount of force required to mate the nose portion 106 with skirt 210 and the tightness of the resulting seal therebetween may be set or adjusted by the presence of annular skirt compression adjustment ferrule 218s (and the dimensions, cross-sectional shape and material thereof, the annular skirt compression adjustment ferrule of this embodiment being formed separately from adapter 280″ and adapter insert 310), in combination with the material characteristics of the skirt, the radial thickness thereof and the axial length thereof receiving the protruding nose portion. As may be appreciated by reference to FIG. 6B, the wall of annular skirt 210 is compressed radially between frustoconical outer surface 108 of nose portion 106 and the arcuate exterior surface of annular skirt compression ferrule 218s, such compression resulting in a more robust engagement between bore wall 226 and frustoconical outer surface 108.

In a variation of the structure depicted in FIGS. 9A and 9B and as illustrated in broken lines with respect to the left-hand-most valve block 100 depicted in those drawing figures, it is contemplated that nose portion 106 may be formed as a separate, easily replaceable piece having a tongue and groove or other type of seal configuration cooperative with a seat of valve block 100, wherein (in the tongue and groove arrangement) an annular protrusion carried on nose portion is sealingly receivable in an interference fit within a mating groove in the seat carried by valve block 100.

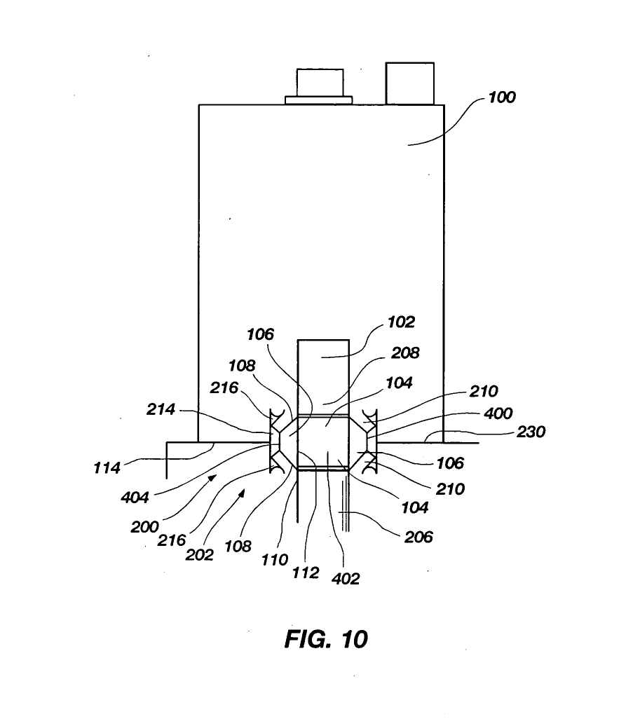

Referring now to FIG. 10 of the drawings, yet another arrangement is depicted for sealing between two components, for example a valve block 100 (only one shown) and a manifold 200. The valve block 100 (valve not shown for clarity) comprises a bore 102 extending thereinto. The lower end (as the drawing sheet is oriented) of bore 102 terminates at a mouth 208 circumscribed by an annular skirt 210 extending coaxially about a longitudinal axis of bore 102 and defining an entry bore of like diameter (e.g., 0.25 inch) when not expanded, to that of bore 102 of a valve block 100, the annular skirt 210 having a radial wall thickness of, for the sake of example only, 0.060 inch. Annular skirt 210 is radially separated from a surrounding, annular coupling bore wall 214 of valve block 100 by an annular recess 216 therebetween. Annular recess 216 of valve block 100 of the present embodiment may, optionally, have an annular bottom defining a convex, semicircular cross section comprising an integral ferrule which extends into annular skirt 210 at its radially inner extent and into annular coupling bore wall 214 at its outer extent. Alternatively, a separate ferrule may be employed, or no ferrule. The distal end of the annular skirt 210 may, optionally and as noted with respect to previous embodiments, comprise a chamfer or radius at the junction of the skirt longitudinal end face and the wall of the entry bore about which the annular skirt 210 extends. The chamfer angle may approximate the angle of the frustoconical outer surface 108 of a protruding nose portion 106 of double-ended nose insert 400 as hereinafter described.

Double-ended nose insert 400 includes back-to-back protruding annular nose portions 106, each having a mouth 104 in mutual communication through nose insert bore 402. Each nose portion 106 includes a frustoconical outer surface 108 tapering radially inwardly toward the distal end 110 thereof, terminating at a relatively sharp annular edge at the junction with bore wall 112, which junction may comprise a very small flat, chamfer or radius. Nose portions may join along a boundary surface 404, which may be arcuate, chamfered or comprise a corner. By way of example only, nose insert bore 402 may be of a 0.25 inch diameter. Proximally behind frustoconical outer surface 108, cylindrical outer surface 114 extends to face surface 116 of valve block 100.

The manifold 200 includes a block 202 with a primary fluid flow path in the form of longitudinal bore (not shown) extending therethrough. Multiple (one shown) side, branch bores 206 typically extend from longitudinal bore 204. The upper end (as the drawing sheet is oriented) of each branch bore 206 terminates at a mouth circumscribed by an annular skirt 210 extending coaxially about a longitudinal axis of branch bore 206 and defining an entry bore of like diameter (e.g., 0.25 inch) to that of a bore 102 of a valve block 100, the annular skirt 210 having a radial wall thickness of, for the sake of example only, 0.060 inch. Annular skirt 210 is radially separated from a surrounding, annular coupling bore wall of manifold 200 by an annular recess 216 therebetween. Annular recess 216 of the present embodiment may have an annular bottom defining a convex, semicircular cross section comprising an integral ferrule which extends into annular skirt 210 at its radially inner extent and into annular coupling bore wall at its outer extent. Alternatively, a separate ferrule may be employed, or no ferrule. The distal end of the annular skirt 210 may, optionally, comprise a chamfer or radius at the junction of the skirt longitudinal end face and the wall of the entry bore about which the annular skirt 210 extends. The chamfer angle may approximate the angle of the frustoconical outer surface 108 of a protruding nose portion of double-ended nose insert 400 as described above.

It should be noted at this point that an O-ring type ferrule of circular transverse cross-section may, optionally, be disposed in the bottom of annular recess 216, when shaped in a concave manner, of either or both of valve block 100 and manifold 200 to modify or control the deformation characteristics of annular skirt 210, as previously described and depicted with respect to FIG. 2A. The ferrule may be of the same, a similar, or a dissimilar material to that used in valve block 100 or manifold 200. In addition, the bottom of annular recess may be flat, and a flat-bottomed ferrule employed, or an integral ferrule formed as described and depicted in FIG. 10.

As shown in FIG. 10, one protruding annular nose portion 106 of double-ended nose insert 400 is inserted coaxially within the annular skirt 210 of valve block 100, while the other is inserted within the annular skirt of manifold 200. The valve block 100 and manifold 200 are forced toward one another along the aligned longitudinal axes of the two components and of double-ended nose insert 400 disposed therebetween until face surface 116 of valve block 100 lies proximate and, optionally, may abut face surface 230 of manifold 200. The protruding annular nose portions 106 double-ended nose insert 400 inserted into the respective annular skirts 210 of the valve block 100 and manifold 200 spread the annular skirts 210 radially outwardly as the inner surface of the annular skirts defining the walls of entry bores sealingly conform to the frustoconical outer surfaces 108 of the protruding annular nose portions 106 due to the resistance of the annular skirts 210 to deformation. As noted above, the resistance of the annular skirt 210 to deformation and, thus, the amount of force required to mate the nose portion 106 with skirt 210 and the tightness of the resulting seal therebetween may be set or adjusted by (in the absence of a skirt compression adjustment ferrule) the material characteristics of the skirt, the radial thickness thereof and the axial length thereof receiving the protruding nose portion.

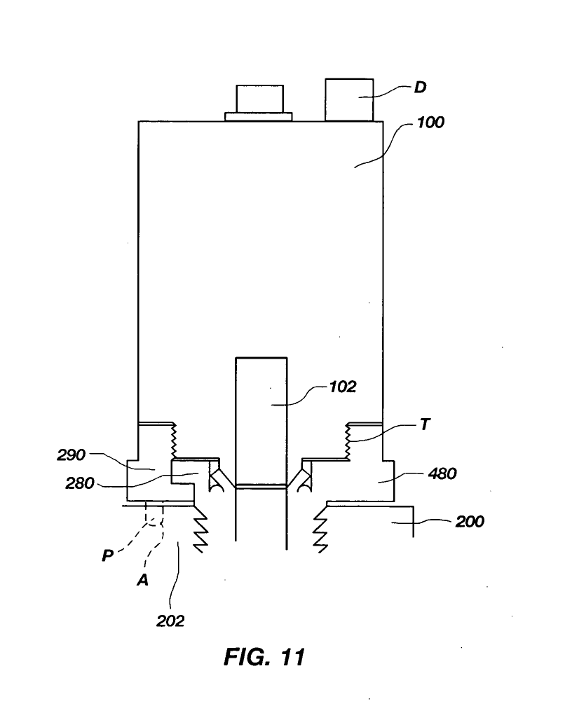

In a variation of the arrangement depicted in FIGS. 6A and 6B depicted in FIG. 11, it is contemplated that a valve block 100 and an adapter block 290 may be threaded together, as depicted at T. In such an instance, adapter block 290 may be provided with locating studs or pins P receivable in mating apertures A formed in manifold block 202 to ensure proper rotational orientation of the valve block/adapter block assembly with respect to manifold 200. Note that rotational alignment is only necessary in instances wherein a valve of valve block 100 is normally in a closed position, as a drive port for actuation of the valve is located on a side of valve block 100. Therefore, as large groups of valve blocks 100 are employed with a manifold as depicted herein and as a plurality of manifolds may lie in close proximity, ensuring a rotational orientation of a given valve block for access to a side-located drive port for a normally closed valve is significant. On the other hand, wherein a valve of a valve block is normally in an open position and is closed by application of driving fluid through a drive port D located on top of valve block 100 as shown, rotational orientation is of no significance. Accordingly, such valve blocks 100 may be of round, rather than square cross-sectional configuration as no bolts or alignment pins are required. Further, in such instances, adapter block 290 and adapter 280 may be formed as a single-piece adapter 480 as shown at the right-hand side of FIG. 11, and threaded *into manifold block 200, valve block 100 in turn being threaded into single-piece adapter 480. Of course, with such a design, locating pins or studs P and mating apertures A are not employed, the absence of same also being shown at the right-hand side of FIG. 11.

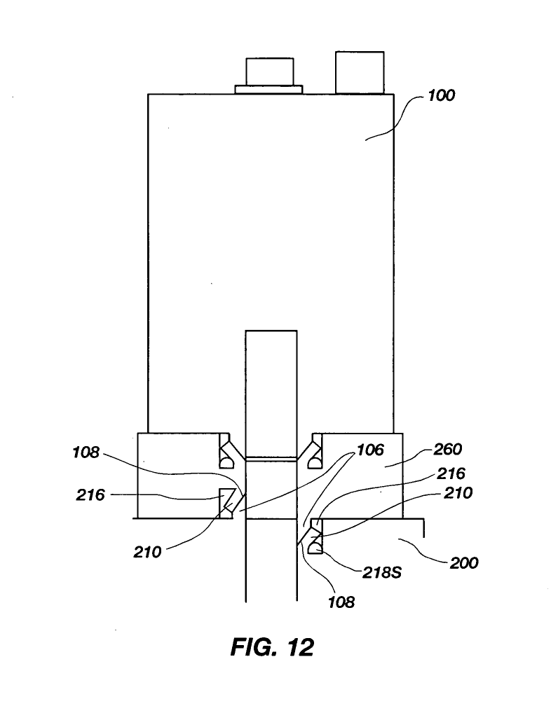

As depicted in FIG. 12, it is contemplated that the coupling of the present invention may be incorporated in connections between other components as previously described herein. For example, rather than employing a tongue-and-groove type seal between an adapter block 260 and a manifold block 202 as depicted in FIGS. 5A and 5B, it is contemplated that a coupling according to the present invention may be employed. As depicted at the left-hand side of the drawing, an annular skirt 210 may be formed in adapter block 260 or, as depicted at the right-hand side of the drawing, an annular skirt may be formed in manifold block 202. Of course, insert-type adapters having annular skirts 210 as depicted in FIGS. 4A and 4B may also be employed in association with either adapter block 260 or manifold block 202. As shown on the left-hand side of the drawing, no ferrule may be provided or, as shown on the right-hand side of the drawing, a separately formed ferrule 218s may be employed. Of course, an O-ring type ferrule, an integral ferrule, or other ferrule configuration may also be employed.

It will be understood that connections between first and second components each having only a single, mutually cooperative coupling element to form a coupling assembly according to the present invention are encompassed by the present invention, as well as connections between first and second components wherein one component has multiple bores and protruding nose portions and is connected to a plurality of other components, each having skirts defining entry bores, or vice versa. The coupling assemblies according to the present invention may be used to connect tubes, pipes or other components including cooperative bores and which may be used to convey liquids or gases across the coupling in a fluid-tight manner. The protruding nose portion, skirt, component body and adapter (if one is employed) of the present invention may be formed of any material capable of accommodating the types of fluids, pressures, temperatures, etc. to which the coupling will be exposed. Suitable materials include, but are not limited to, polymeric materials such as fluoropolymeric compounds including without limitation tetrafluoroethylene (TFE), polytetrafluoroethylene (PTFE), fluorinated ethylene-propylene (FEP), perfluoroalkoxy fluorocarbon resin (PFA), polychlorotrifluoroethylene (PCTFE), ethylene-chlorotrifluoroethylene copolymer (ECTFE), ethylene-tetrafuoroethylene copolymer (ETFE), polyvinylidene fluoride (PVDF), and polyvinyl fluoride (PVF).

As noted previously, in all of the embodiments the length of the annular outer surface of the nose portion of the first component along the surface thereof may approximate a longitudinal length of the annular skirt of the second component, measured from a base thereof laterally adjacent the bottom of the annular recess. Further, the longitudinal length of the nose portion may be selected relative to a face surface of the first component which abuts a cooperative face surface of the second component when the first and second components are coupled to control the insertion depth of the nose portion into the annular skirt. Thus, the insertion depth may be optimized to provide a substantially uninterrupted, smooth-walled bore of substantially constant diameter extending through the coupling assembly. The annular skirt is permitted to spread outwardly into the annular recess as the nose portion extends thereinto, and its relatively short length prevents contact with the outer wall of the annular recess at least until the annular outer surface of the nose portion is substantially received within the annular skirt, and prevents binding with the outer wall of the annular recess and any portion of the first component proximal of the outer frustoconical surface of the nose portion which would comprise the seal of the coupling assembly.

Although specific embodiments have been shown by way of example in the drawings and have been described in detail herein, the invention may be susceptible to various modifications, combinations, and alternative forms. For example, a manifold or other component having any number of bores is within the scope of the present invention. Therefore, it should be understood that the present invention is not intended to be limited to the particular forms disclosed. Rather, the present invention includes all modifications, equivalents, combinations, and alternatives falling within the spirit and scope of the invention as defined by the following appended claims.

1. A coupling assembly, comprising:
at least one first component having a protruding annular nose portion extending therefrom and having a longitudinal axis and a bore extending coaxially therethrough, the nose portion including a frustoconical outer surface; and
at least one second component comprising a body carrying an annular skirt extending coaxially about a longitudinal axis and defining a bore;
wherein the frustoconical outer surface of the nose portion of the at least one first component is received within the annular skirt.

2. The coupling assembly of claim 1, wherein the at least one first component further includes a face surface, the at least one second component includes a face surface abutting the face surface of the at least one first component, and the first and second face surfaces are respectively located and oriented relative to a length of the protruding nose portion and a length of the annular skirt to control a depth of receipt of the nose portion within the annular skirt.

3. The coupling assembly of claim 1, wherein the annular skirt is surrounded by an annular recess having an outer periphery defined by an annular coupling bore wall and having a bottom proximate a base of the annular skirt.

4. The coupling assembly of claim 3, further comprising an annular skirt compression adjustment ferrule disposed proximate the bottom of the annular recess.

5. The coupling assembly of claim 4, wherein the annular skirt compression adjustment ferrule is formed integrally with a portion of the at least one second component comprising the annular skirt.

6. The coupling assembly of claim 4, wherein the annular skirt compression adjustment ferrule comprises a separate element disposed on the bottom of the annular recess.

7. The coupling assembly of claim 4, wherein at least an upper portion of the annular skirt compression adjustment ferrule has a semicircular transverse cross section.

8. The coupling assembly of claim 1, wherein the nose portion further comprises a cylindrical surface proximal of the frustoconical outer surface.

9. The coupling assembly of claim 1, wherein the annular skirt comprises a chamfer at a junction of a longitudinal end face and a wall of the bore thereof, the chamfer having an angle approximating the angle of the frustoconical outer surface.

10. The coupling assembly of claim 1, wherein the at least one second component comprises a body configured as a manifold and carrying a plurality of annular skirts, each extending coaxially about a longitudinal axis and defining a bore, and the at least one first component comprises a plurality of first components, wherein a bore of each of the plurality of first components is coupled to one of the bores of the manifold.

11. The coupling assembly of claim 1, wherein the at least one first component comprises a single first component, and the at least one second component comprises a single second component.

12. The coupling assembly of claim 1, wherein the at least one first component comprises a plurality of nose portions, each defining a bore and the at least one second component comprises a plurality of second components, wherein a bore of each of the plurality of second components is coupled to one of the bores of the at least one first component.

13. The coupling assembly of claim 1, wherein the body comprises an adapter disposed in an adapter bore of the at least one second component defined at its outer periphery by an annular coupling bore wall and having a bottom including an annular groove therein, wherein the body comprises an annular protrusion received in the annular groove.

14. The coupling assembly of claim 13, wherein the annular groove lies adjacent the annular coupling bore wall, a radially outer wall of the annular groove comprises the annular coupling bore wall and an outer surface of the annular protrusion comprises a peripheral surface of the adapter.

15. The coupling assembly of claim 1, wherein the body comprises an adapter disposed on a surface of the at least one second component, the annular skirt is surrounded by an annular recess in the adapter, the adapter comprises an annular protrusion and the surface of the at least one second component comprises an annular groove receiving the annular protrusion.

16. The coupling assembly of claim 1, wherein the body comprises an adapter having the annular skirt and a surrounding annular recess formed therein, the adapter having a threaded outer surface disposed in a threaded adapter bore of the at least one second component having a bottom including an annular groove therein, wherein the adapter comprises an annular protrusion received in the annular groove.

17. The coupling assembly of claim 16, wherein the at least one second component further comprises an adapter block disposed about the adapter, the adapter block comprising a bore and a larger counterbore through which the adapter extends, the adapter comprising a flange received within the counterbore.

18. The coupling assembly of claim 16, wherein the at least one second component further comprises a bore and a larger counterbore above the threaded adapter bore through which the adapter extends, the adapter comprising a flange received within the counterbore.

19. The coupling assembly of claim 16, wherein the adapter further comprises an adapter insert having the annular skirt formed therein, the adapter insert being received within an insert bore in the adapter, an outer wall of the insert bore defining an outer periphery of an annular recess surrounding the annular skirt, a bottom of the insert bore having an annular groove therein receiving an annular protrusion on a bottom surface of the adapter insert.

20. The coupling assembly of claim 19, wherein an outer wall of the annular groove comprises the outer wall of the insert bore and an outer surface of the annular protrusion comprises an outer surface of the adapter insert.

21. The coupling assembly of claim 1, wherein a longitudinal length of the annular skirt approximates a length of the frustoconical surface, taken along the surface thereof.

22. The coupling assembly of claim 1, wherein the at least one second component comprises an annular recess surrounding the annular skirt and a face surface at the mouth of the annular recess transverse to the longitudinal axis about which the annular skirt extends, and the annular skirt does not protrude beyond the face surface.

23. The coupling assembly of claim 22, wherein the at least one first component comprises a cylindrical outer surface proximal of the frustoconical outer surface, and a face surface at a base of the cylindrical outer surface and extending transverse to the longitudinal axis of the nose portion.

24. The coupling assembly of claim 1, wherein the protruding annular nose portion comprises a discrete structure engaged with the at least one first component.

25. A method of coupling a first component having a bore to a second component having a bore, the method comprising:
providing a protruding nose portion having a frustoconical outer surface thereon and surrounding a bore of the first component;
providing an annular skirt surrounding a bore of the second component; and
inserting the protruding nose portion into the annular skirt until a distal end of the annular skirt lies proximate a base of the frustoconical nose portion.

26. The method of claim 25, further comprising spreading the annular skirt as the protruding nose portion is inserted thereinto to form a seal between an interior surface of the annular skirt and the frustoconical surface of the protruding nose portion.

27. The method of claim 25, further comprising placing an annular component proximate and about the annular skirt, and compressing the annular skirt between the annular component and the protruding nose portion as the protruding nose portion is inserted into the annular skirt.

28. A coupling assembly, comprising:
a first component having a longitudinal axis and a bore extending therethrough between first and second protruding annular nose portions in back to back relationship, each nose portion including a frustoconical outer surface;
a second component comprising a body carrying an annular skirt extending coaxially about a longitudinal axis and defining a bore, wherein the frustoconical outer surface of the first nose portion of the first component is received within the annular skirt of the second component; and
a third component comprising a body carrying an annular skirt extending coaxially about a longitudinal axis and defining a bore, wherein the frustoconical outer surface of the second nose portion of the first component is received within the annular skirt of the third component.
